(19) United States
(12) Patent Application Publication
(10) Pub. No.: US 2024/0002608 A1
(43) Pub. Date: Jan. 4, 2024

(54) (POLY)OL BLOCK COPOLYMER

(71) Applicant: ECONIC TECHNOLOGIES LTD., Macclesfield, Cheshire (GB)

(72) Inventors: Michael KEMBER, Macclesfield (GB); James LEELAND, Macclesfield (GB); Kerry RILEY, Macclesfield (GB)

(21) Appl. No.: 18/035,669

(22) PCT Filed: Nov. 4, 2021
(86) PCT No.: PCT/GB2021/052865

§ 371 Date: May 5, 2023

(30) Foreign Application Priority Data
Nov. 5, 2020 (GB) 2017531.1

(51) Int. Cl. C08G 81/00; C08G 65/26; C08G 63/64; C08G 63/08; C08G 64/34

(52) U.S. Cl. CPC C08G 81/00; C08G 65/2615; C08G 63/64; C08G 2261/126; C08G 64/34; C08G 65/2663; C08G 63/08

(57) ABSTRACT

(Poly)ol block copolymers having a polycarbonate or polyether carbonate, polyester and polyether or ethercarbonate blocks of structure

C—B-A′-Z′—Z—(Z′-A′-B—C)ₙ
wherein n=t−1 and wherein t=the number of terminal OH group residues on the block A; and
wherein each A′ is independently a polycarbonate chain having at least 70% carbonate linkages, or a polyethercarbonate chain having at least 30% ether linkages, wherein each B is a (poly)ester block formed by epoxide and cyclic anhydride reaction/copolymerisation and/or cyclic ester ring-opening reaction % polymerisation, and each C is independently a (poly)ethercarbonate or (poly)ether block having 50-100% ether linkages; and wherein Z′—Z—(Z′)ₙ is a starter residue. Block B may have one of the following structures

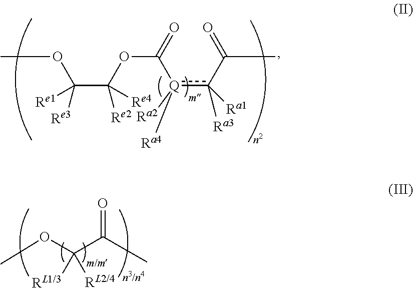

wherein n² is 1 or more and n³/n⁴ is 1 or more, which extends to higher polymers such as polyurethanes produced from copolymers, compositions and processes of production of such polyols.

### TECHNICAL FIELD

The present invention relates to (poly)ol block copolymers, more specifically, to (poly)ol block copolymers having a polycarbonate or polyether carbonate, polyester and polyether or ethercarbonate blocks. The invention extends to higher polymers such as polyurethanes produced from such polyols, polyol and higher polymer containing products and compositions and processes of production of such polyols.

### BACKGROUND

Incorporation of carbon dioxide into polycarbonate polyols has been known for several years using DMC catalysts to produce polyethercarbonate polyols. Incorporating more carbon dioxide, a greenhouse gas, into such polyols is desirable due to the environmental benefits. Polycarbonate polyols from carbon dioxide and epoxide with high carbonate content using salen and porphyrin based carbonate catalyst were developed and are disclosed in a number of patent applications, for example, WO2010028362. However, although the salen and porphyrin catalysts can give high carbonate content they also produce polyols which have high viscosity with poor thermal stability and stability to basic conditions due to “unzipping” of the polymer chain ends. WO2010062703 discloses various block copolymers for use as surfactants having a polyether carbonate or poly carbonate block and a hydrophilic block such as a polyether. Various techniques and catalysts are disclosed including a triblock polyether-polycarbonate-polyether triblock produced using a salen catalyst and a DMC catalyst and a low molecular weight chain transfer agent. The polymer produced was described as a viscous oil.

Improved carbonate catalysts that produce high carbonate content have also been developed as exemplified in WO2013/034750, WO2016/012786 and WO2016/012785, these produce polyols with high selectivities even at elevated temperatures (>50° C.) but the polyols high carbonate content still leaves them vulnerable to ‘unzipping’ after production.

U.S. Ser. No. 10/308,759 (WO2015154001) discloses a method of reducing instability caused by degradation or ‘unzipping’ of the polycarbonate chain ends by adding an anhydride end cap to the carbonate polyol and then reacting a single epoxide with the new chain ends to restore the OH end groups to the polymer. U.S. Ser. No. 10/308,759 teaches that polymerization of the epoxide groups at the chain ends is undesirable and leads to increases in molecular weight or undesirable properties introduced by the polyether ends groups. The polymers produced by U.S. Ser. No. 10/308,759 still have the problem of high viscosity and are difficult to use. Processing of these polyols requires solvents and multiple isolations steps.

The same process and triblocks as WO2010062703 are disclosed in WO2020068796. The polyether blocks are provided to provide greater stability. However, end-capping in WO2020068796 is not complete due to competition between chain transfer and polymerization rates. All the reactions are required to be carried out at room temperature or below and/or with excess epoxide to prevent thermal decomposition of the polycarbonate in the second polymerization step.

Polyether carbonates produced by DMC catalysts are known from US2009/0306239 (WO2008058913) and polyether end blocks have been provided by using excess epoxide and continuing the polymerisation. The polyether end blocks are provided to prevent undesirable chain unzipping to produce cyclic by-products. However, such polyols require high pressure, have low carbonate content, high molecular weight and can still introduce unstable carbonate units towards end of polymer chain, where there is possibility to ‘unzip’ the polymer chains.

Furthermore, terpolymers of polyetherester carbonate polyols from carbon dioxide, alkylene oxide and cyclic anhydrides (e.g. US2016/0362518 (WO2015128277), US2014/0329987 (WO2013087582)) have been demonstrated using a DMC catalyst alone. The use of cyclic anhydrides helps give better selectivity than without but again produces polymers with only relatively low CO₂ contents (<30% carbonate linkages, ˜<15 wt % CO₂). Various types of polymers are mentioned including blocks but no specific block structures are presented and the document and examples generally relate to random polymerized terpolymer structures.

WO2014/184578 is directed to a method of making block copolymers using a single catalyst system which include polycarbonate blocks and polyester blocks and optionally further blocks. However, no specific triblocks with polycarbonate or polyethercarbonate—polyester—polyether or polyethercarbonate end blocks are mentioned and end blocks with at least 50% ether linkages are not envisioned or obtainable by the single catalyst system.

An object of the present invention is to address these and other problems with such block copolymers and their processes of production.

The inventors have surprisingly found that a triblock structure having a polycarbonate or polyethercarbonate core, ester or polyester blocks at the end of the core and ether, polyether or polyether carbonate chain ends leads to improved stability of not only the polyol but the addition of the ester at the end of the core can also provide improved selectivity during production by preventing decomposition of the polycarbonate in the (poly)ether/(poly)ether carbonate forming reaction, even at elevated temperatures suitable for industrial processes. In addition, such polyols can also have lower viscosity which can lead to improvements in processing. In addition, such triblock polyols have more possibility for variation in properties for end use applications due to the presence of three blocks. Still further, the process of production can also provide more flexibility in the process of production as the second block may be introduced by catalysts that are also used for the core block and/or catalysts that are used for the end blocks. Thus the (poly)ester can be added in a first reactor at the end of a first reaction that produces the core block or in a second reactor before a third reaction that produces the end blocks.

The core block of the present invention can contain significantly increased CO₂ content (e.g. >20 wt %) introduced under mild pressures Advantageously, low molecular weight polycarbonate or polyether carbonate block polyester polyols e.g. <1000 Mn) can remain unisolated and transferred from one reactor directly into a second without removing any catalyst, unreacted monomer or solvents.

WO2017037441 describes a process where a carbonate catalyst and a DMC catalyst are used in one reactor to produce a polyethercarbonate polyol. The conditions of the reaction must be balanced to meet the needs of two different catalysts. Advantageously, the invention can allow optimisation of the conditions for use of two different types of catalyst, a carbonate catalyst and a catalyst for the (poly)ether or (poly)ethercarbonate end block such as a DMC catalyst, enabling optimisation of conditions for each catalyst individually rather than compromising to suit the overall system. The ester block reaction can then be carried out in the most favourable reactor. The block polyol intermediate can also be added directly to a pre-activated DMC catalyst, which is more desirable as it reduces cycle times and increases process safety by limiting unreacted monomer content in the reactor.

Furthermore, the invention can be used to produce unique block copolymers which may contain a core of high carbonate content chains with a terminal block of high ether content chains and an intermediate ester or polyester block that provides increased stability both during and after production. As mentioned above, the triblock polyols have more possibility for variation in properties for end use applications due to the presence of three blocks. The intermediate block provides the possibility of introducing esters with specific properties that can modify the properties of the final polyol or higher polymer products. For example, using phthalic anhydride may enhance flammability performance due to increased aromatic content or using maleic anhydride provides potential cross-linking functionality due to the free double bond. Additionally, the ester linkages in the middle blocks could increase other properties for example the ester units could increase performance in PU strength, adhesion, oil resistance. Polyurethanes made from such polyols can benefit from the advantages of high carbonate linkages (e.g. increased strength, increased chemical resistance, resistance to both hydrolysis and oil etc) whilst still retaining the higher thermal stability that the ester/polyester block and high ether content end blocks provide. Accordingly, the present invention provides polyols with a high degree of flexibility in the use of polycarbonates or polyether carbonates that has not hitherto been possible in such a stable form.

The polyols can advantageously be made using the same or similar epoxide reactants and CO₂ in the relevant reactions.

The use of an intermediate (poly)ester block can provide improved stability of the intermediate product which means higher process temperatures are possible. In some embodiments it is possible to store the intermediate product due to its stability. The viscosity of the intermediate product can also lead to less solvent and easier purification being possible.

### SUMMARY OF THE INVENTION

According to the present invention there is provided a (poly)ol block copolymer as defined by the claims.

For the avoidance of doubt, when t=1 then n=0 and the polyblock structure is: —

C—B-A′-Z′—Z

The polycarbonate or polyether carbonate block comprises -A′- which may have the following structure:

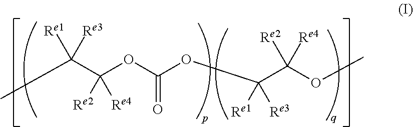

wherein in the case of the polycarbonate chain if q is not 0, the ratio of p:q is at least 7:3 and wherein in the case of the polyethercarbonate chain the ratio of p:q is at least 3:7;
and
R^{e1}, R^{e2}, R^{e3} and R^{e4} depend on the nature of the epoxide used to prepare blocks A.

The block B has one of the following structures

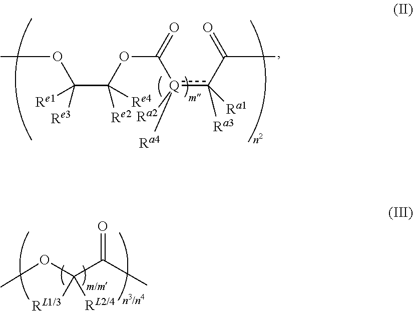

wherein n² is 1 or more and n³/n⁴ is 1 or more

The block C may have the following structure:

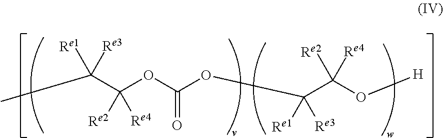

wherein w is 1 or more and v is 0 or more and if v is not 0, the ratio of w:v is at least 1:1; with the proviso that if the total of n² and n³/n⁴ is 1 then w is at least 2 and if w is 1 then the total of n² and n³/n⁴ is at least 2;
R^{e1}, R^{e2}, R^{e3} and R^{e4} independently depend on the epoxide residue in the respective block;
R^{a1}, R^{a2}, R^{a3} and R^{a4} or R^{L1/L3}, R^{L2/L4}, m, m′ and m″ depend on the cyclic anhydride or ester residue in block B.

Each R^{e1}, R^{e2}, R^{e3}, or R^{e4} may be independently selected from H, halogen, hydroxyl, or optionally substituted alkyl, alkenyl, alkynyl, cycloalkyl, heterocycloalkyl, aryl, heteroaryl, heteroalkyl or heteroalkenyl, preferably selected from H or optionally substituted alkyl.

R^{e1} or R^{e3} and R^{e2} or R^{e4} may together form a saturated, partially unsaturated or unsaturated ring containing carbon and hydrogen atoms, and optionally one or more heteroatoms.

As set out above, the nature of R^{e1}, R^{e2}, R^{e3} and R^{e4} will depend on the epoxide used in the reaction. For example, if the epoxide is cyclohexene oxide (CHO), then R^{e1} or R^{e3} and R^{e2} or R^{e4} will together form a six membered alkyl ring (e.g. a cyclohexyl ring). If the epoxide is ethylene oxide, then R^{e1}, R^{e2}, R^{e3} and R^{e4} will be H. If the epoxide is propylene oxide, then three of R^{e1}, R^{e2}, R^{e3} and R^{e4} will be H and one will be methyl, depending on how the epoxide is added into the polymer backbone. If the epoxide is butylene oxide, then three of R^{e1}, R^{e2}, R^{e3} and R^{e4} will be H and one will be ethyl. If the epoxide is styrene oxide, then three of R^{e1}, R^{e2}, R^{e3} and R^{e4} will be H and one will be phenyl. If the epoxide is a glycidyl ether, then three of R^{e1}, R^{e2}, Rₑ₃ and R^{e4} will be H and one will be an ether group (—CH₂—OR₂₀). If the epoxide is a glycidyl ester, then three of R^{e1}, R^{e2}, R^{e3} and R^{e4} will be H and one will be an ester group (—CH₂—OC(O)R₁₂). If the epoxide is a glycidyl carbonate, then three of R^{e1}, R^{e2}, R^{e3} and R^{e4} will be H and one will be a carbonate group (CH₂—OC(O)OR₁₈).

It will also be appreciated that if a mixture of epoxides are used, then each occurrence of R^{e1}, R^{e2}, R^{e3} and R^{e4} may not be the same, for example if a mixture of ethylene oxide and propylene oxide are used, R^{e1}, R^{e2}, R^{e3} and R^{e4} may be independently hydrogen or methyl.

It will also be appreciated that each occurrence of R^{e1}, R^{e2}, R^{e3} and R^{e4} in each block may be the same or different to the corresponding R^{e1}, R^{e2}, R^{e3} and R^{e4} in the remaining blocks.

Thus, R^{e1}, R^{e2}, R^{e3} and R^{e4} may be independently selected from hydrogen, alkyl or aryl, or R^{e1} or R^{e3} and R^{e2} or R^{e4} may together form a cyclohexyl ring, preferably R^{e1}, R^{e2}, R^{e3} and R^{e4} may be independently selected from hydrogen, methyl, ethyl or phenyl, or R^{e1} or R^{e3} and R^{e2} or R^{e4} may together form a cyclohexyl ring.

The identity of Z and Z′ will depend on the nature of the starter compound.

The starter compound may be of the formula (V):

Z [symbol] R^{Z})ₐ (V)

Z can be any group which can have 1 or more —R^{Z} groups attached to it, preferably 2 or more —R^{z} groups attached to it. Thus, Z may be selected from optionally substituted alkylene, alkenylene, alkynylene, heteroalkylene, heteroalkenylene, heteroalkynylene, cycloalkylene, cycloalkenylene, hererocycloalkylene, heterocycloalkenylene, arylene, heteroarylene, or Z may be a combination of any of these groups, for example Z may be an alkylarylene, heteroalkylarylene, heteroalkylheteroarylene or alkylheteroarylene group. Optionally Z is alkylene, heteroalkylene, arylene, or heteroarylene.

It will be appreciated that a is an integer which is at least 1, preferably at least 2. Optionally a is in the range of between 1 and 8, optionally a is in the range of between 2 and 6.

Each R^{Z} may be —OH, —NHR′, —SH, —C(O)OH, —P(O)(OR′)(OH), —PR′(O)(OH)₂ or —PR′(O)OH, optionally R^{Z} is selected from —OH, —NHR′ or —C(O)OH, optionally each R^{z} is —OH, —C(O)OH or a combination thereof (e.g. each R^{z} is —OH).

R′ may be H, or optionally substituted alkyl, heteroalkyl, aryl, heteroaryl, cycloalkyl or heterocycloalkyl, optionally R′ is H or optionally substituted alkyl.

Z′ corresponds to R^{z}, except that a bond replaces the labile hydrogen atom. Therefore, the identity of each Z′ depends on the definition of R^{Z} in the starter compound. Thus, it will be appreciated that each Z′ may be —O—, —NR′—, —S—, —C(O)O—, —P(O)(OR′)O—, —PR′(O)(O—)₂ or —PR′(O)O— (wherein R′ may be H, or optionally substituted alkyl, heteroalkyl, aryl, heteroaryl, cycloalkyl or heterocycloalkyl, preferably R′ is H or optionally substituted alkyl), preferably Z′ may be —C(O)O—, —NR′— or —O—, more preferably each Z′ may be —O—, —C(O)O— or a combination thereof, more preferably each Z′ may be —O—. Preferably, the (poly)ol block copolymer has a molecular weight (Mn) in the range of from about 300 to 20,000 Da, more preferably in the range of from about 400 to 8000 Da, most preferably from about 500-6000 Da.

The polycarbonate or polyether carbonate block, A, of the (poly)ol block copolymer preferably has a molecular weight (Mn) in the range of from about 200 to 4000 Da, more preferably in the range of from about 200 to 2000 Da, most preferably from about 200 to 1000 Da, especially from about 400 to 800 Da.

The (poly)ester blocks, B, of the (poly)ol block copolymer preferably have a molecular weight (Mn) in the range of from about 50 to 5,000 Da, more preferably of from about 50 to 1,000 Da, most preferably from about 50 to 500 such as 50-400 Da.

The (poly)ether or (poly)ethercarbonate blocks, C, of the (poly)ol block copolymer preferably have a molecular weight (Mn) In the range of from about 100 to 20,000 Da, more preferably of from about 200 to 10,000 Da, most preferably from about 200 to 5000 Da.

Alternatively, the (poly)ether or (poly)ethercarbonate blocks C and hence also the (poly)ol block copolymer may have a high molecular weight. The (poly)ether or (poly)ethercarbonate blocks C may have a molecular weight of at least about 25,000 Daltons, such as at least about 40,000 Daltons, e.g. at least about 50,000 Daltons, or at least about 100,000 Daltons. High molecular weight (poly)ol block copolymers formed by the method of the present invention may have molecular weights above about 100,000 Daltons.

The Mn and hence the PDI of the polymers defined herein and/or produced by the processes of the invention may be measured using Gel Permeation Chromatography (GPC). For example, the GPC may be measured using an Agilent 1260 Infinity GPC machine with two Agilent PLgel μ-m mixed-D columns in series. The samples may be measured at room temperature (293K) in THF with a flow rate of 1 mL/min against narrow polystyrene standards (e.g. polystyrene low EasiVials supplied by Agilent Technologies with a range of Mn from 405 to 49,450 g/mol). Optionally, the samples may be measured against poly(ethylene glycol) standards, such as polyethylene glycol easivials supplied by Agilent Technologies.

The polycarbonate block, A, of the polyol clock copolymer may have at least 76% carbonate linkages, preferably at least 80% carbonate linkages, more preferably at least 85% carbonate linkages. Block A may have less than 98% carbonate linkages, preferably less than 97% carbonate linkages, more preferably less than 95% carbonate linkages. Optionally, such a block A has between 75% and 99% carbonate linkages, preferably between 77% and 95% carbonate linkages, more preferably between 80% and 90% carbonate linkages.

The polyether carbonate block, A, of the (poly)ol block copolymer may have at least 32% ether linkages preferably at least 35% ether linkages, more preferably at least 40% ether linkages. Block A may have less than 70% ether linkages, preferably less than 65% ether linkages, more preferably less than 60% ether linkages. Optionally, such a block A has between 30% and 90% ether linkages, preferably between 30% and 70% ether linkages, more preferably between 30% and 50% ether linkages.

The (poly)ether or (poly)ethercarbonate blocks, C, of the (poly)ol block copolymer may have less than 40% carbonate linkages, preferably less than 30% carbonate linkages, more preferably less than 20% carbonate linkages. Block C may have 0% or up to 5% carbonate linkages, typically, up to 10% carbonate linkages, more typically, up to 15% or 20% carbonate linkages. Optionally, block C may have between 0% and 50% carbonate linkages, typically between 0% and 35% carbonate linkages, more typically between 0% and 20% carbonate linkages.

The (poly)ether or (poly)ethercarbonate blocks, C, of the (poly)ol block copolymer may have at least 60% ether linkages, preferably at least 70% ether linkages, more preferably at least 80% ether linkages. The (poly)ethercarbonate blocks, C, of the (poly)ol block copolymer may have less than 95% ether linkages, preferably less than 90% ether linkages, more preferably less than 85% ether linkages. Optionally, block C may have between 50% and 100% ether linkages, preferably between 65% and 100% ether linkages, more preferably between 80% and 100% ether linkages.

The polycarbonate block, A, of the (poly)ol block copolymer may also comprise ether linkages. Block A may have less than 24% ether linkages, preferably less than 20% ether linkages, more preferably less than 15% ether linkages. Block A may have at least 1% ether linkages, preferably at least 3% ether linkages, more preferably at least 5% ether linkages. Optionally, block A may have between 1% and 25% ether linkages, preferably between 5% and 20% ether linkages, more preferably between 10% and 15% ether linkages.

Optionally, block A may be a generally alternating polycarbonate polyol residue.

If the epoxide is asymmetric, then the polycarbonate or polyethercarbonate may have between 0-100% head to tail linkages, preferably between 40-100% head to tail linkages, more preferably between 50-100%. The polycarbonate or polyethercarbonate may have a statistical distribution of head to head, tail to tail and head to tail linkages in the order 1:2:1, indicating a non-stereoselective ring opening of the epoxide, or it may preferentially make head to tail linkages in the order of more than 50%, optionally more than 60%, more than 70%, more than 80%, or more than 90%.

Typically, the mol/mol ratio of epoxide residues in block A to epoxide and, optionally, cyclic ester residues in block B and C combined is in the range 25:1 to 1:250. Typically the weight ratio of block A to block B and C combined is in the range 50:1 to 1:100.

Typically, block A, the polycarbonate or polyether carbonate block, is derived from epoxide and CO₂, more typically, epoxide and CO₂ provide at least 90% of the residues in the block, especially, at least 95% of the residues in the block, more especially, at least 99% of the residues in the block, most especially, about 100% of the residues in the block are residues of epoxide and CO₂. Most typically, block A includes ethylene oxide and/or propylene oxide residues and optionally other epoxide residues such as cyclohexylene oxide, butylene oxide, glycidyl ethers, glycidyl esters and glycidyl carbonates. At least 30% of the epoxide residues of block A may be ethylene oxide or propylene oxide residues, typically, at least 50% of the epoxide residues of block A are ethylene oxide or propylene oxide residues, more typically, at least 75% of the epoxide residues of block A are ethylene oxide or propylene oxide residues, most typically, at least 90% of the epoxide residues of block A are ethylene oxide or propylene oxide residues.

Typically, the carbonate of block A is derived from CO₂ i.e. the carbonates incorporate CO₂ residues. Typically, if block A is a polycarbonate it has between 70-100% carbonate linkages, more typically, 80-100%, most typically, 90-100%. If block A is a polyethercarbonate it has between 10 and 70% carbonate linkages, more typically, 30 and 70% carbonate linkages and most typically, 50-70% carbonate linkages.

Typically, block C, the (poly)ether or (poly)ethercarbonate block, is derived from epoxides and optionally CO₂. Typically, epoxide and CO₂ provide at least 90% of the residues in the block, especially, at least 95% of the residues in the block, more especially, at least 99% of the residues in the block, most especially, about 100% of the residues in the block are residues of epoxide and optionally CO₂. Most typically, block C includes ethylene oxide and/or propylene oxide residues and optionally other epoxide residues such as cyclohexylene oxide, butylene oxide, glycidyl ethers, glycidyl esters and glycidyl carbonates. At least 30% of the epoxide residues of block C may be ethylene oxide or propylene oxide residues, typically, at least 50% of the epoxide residues of block C are ethylene oxide or propylene oxide residues, more typically, at least 75% of the epoxide residues of block C are ethylene oxide or propylene oxide residues, most typically, at least 90% of the epoxide residues of block C are ethylene oxide or propylene oxide residues.

Optionally, block C incorporates CO₂ residues in the carbonate groups. Alternatively, block C is a (poly)ether with 0% carbonate groups.

Optionally, block C is a polyether chain selected from the group consisting of polyoxymethylene, poly(ethylene oxide), poly(propylene oxide), poly(butylene oxide), poly(glycidylether oxide), poly(chloromethylethylene oxide), poly(cyclopentene oxide), poly(cyclohexene oxide) and poly(3-vinyl cyclohexene oxide).

Typically, block B is a (poly)ester chain formed by epoxide and cyclic anhydride reaction/copolymerisation and/or cyclic ester ring-opening reaction/polymerisation,

The (poly)esters produced by the reaction between an epoxide and a cyclic anhydride in the presence of a catalyst as defined herein may be represented as follows:

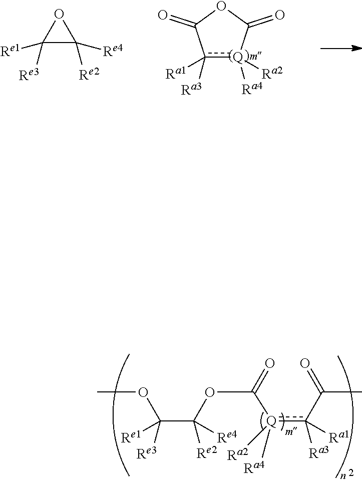

wherein n² is 1 or more, for example 2 or more and may be in the range 1 to 10,000 for example 1 to 1000, such as 1 to 100, e.g. 2, 3, 4, or 5 to 10 or 100 or 1000 or 10,000.

The ring opening of a cyclic ester such as a lactone or a cyclic diester in the presence of a catalyst system as defined herein may be represented by scheme 1 and 2 as follows:

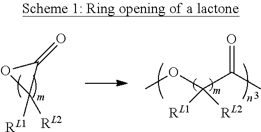

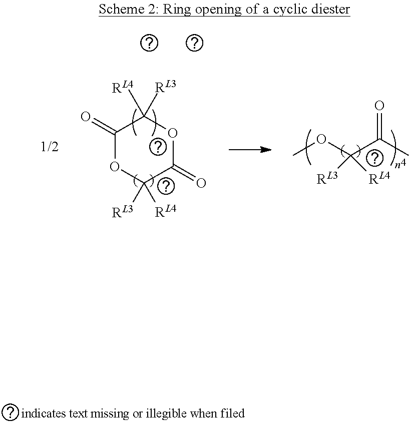

In the above schemes, n³ and n⁴ are independently selected from 1 or more, for example 2 or more and may be in the range 1 to 10 000, for example 1 to 1000, such as 1 to 100, e.g. 2, 3, 4, or 5 to 10 or 100 or 1000 or 10,000. The inventive methods described herein can therefore be used to ring open a lactide and/or a lactone in order to make (poly)ester blocks of dimers, trimers, tetramers, pentamers etc (i.e. when n³ or n⁴=2, 3, 4, 5) or polymers (i.e. when n³ or n⁴=1 to 10,000).

In a particular embodiment of the invention, for the process of the invention first produces a polycarbonate or polyethercarbonate-(poly)ester block copolymer, the method comprising initially

polymerising carbon dioxide and an epoxide in the presence of a catalytic system to form a polycarbonate with a carbonate catalyst such as that of formula (VII) or a polyether carbonate block with an ethercarbonate catalyst such as a DMC catalyst and, adding anhydride (and optionally further epoxide, which may be the same or different to the epoxide used to produce the first block) to the reaction mixture. This reaction may be represented in a simplified form, without starter shown, as follows:

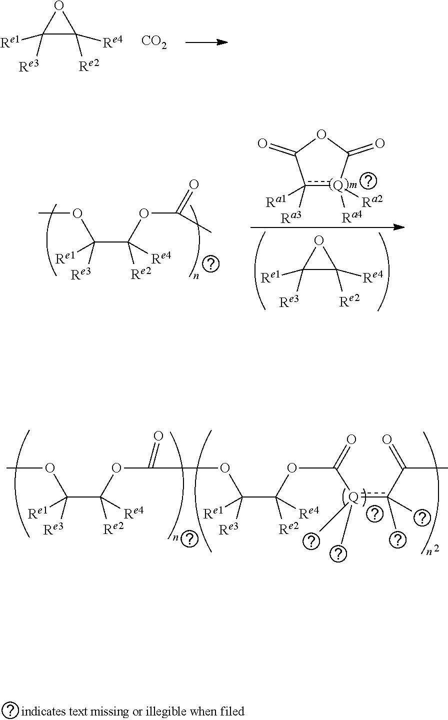

In the above reaction, it will be appreciated that further epoxide will need to be added to the reaction mixture in order to produce the second block if all of the epoxide has been consumed in the production of the first block.

It is possible that the epoxide monomer used to produce the second block may be added to the catalytic system at the same time as the anhydride/carbon dioxide, or it may be present in the catalytic system prior to the production of the first block.

Where the second reaction is a ring-opening reaction of a cyclic ester, this reaction can be represented in a simplified form, without starter shown, as follows:

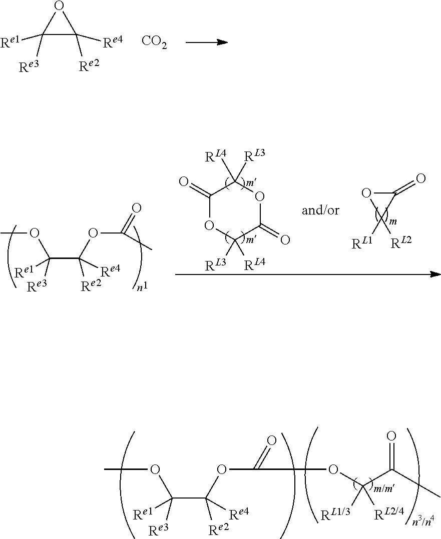

According to a second aspect of the present invention there is provided a composition comprising the (poly)ol block copolymer as defined by the claims.

The composition may also comprise of one or more additives from those known in the art. The additives may include, but are not limited to, catalysts, blowing agents, stabilizers, plasticisers, fillers, flame retardants, defoamers, and antioxidants.

Fillers may be selected from mineral fillers or polymer fillers, for example, styrene-acrylonitrile (SAN) dispersion fillers.

The blowing agents may be selected from chemical blowing agents or physical blowing agents. Chemical blowing agents typically react with (poly)isocyanates and liberate volatile compounds such as CO₂. Physical blowing agents typically vaporize during the formation of the foam due to their low boiling points. Suitable blowing agents will be known to those skilled in the art, and the amounts of blowing agent added can be a matter of routine experimentation. One or more physical blowing agents may be used or one or more chemical blowing agents may be used, in addition one or more physical blowing agents may be used in conjunction with one or more chemical blowing agents.

Chemical blowing agents include water and formic acid. Both react with a portion of the (poly)isocyanate producing carbon dioxide which can function as the blowing agent. Alternatively, carbon dioxide may be used directly as a blowing agent, this has the advantage of avoiding side reactions and lowering urea crosslink formation, if desired water may be used in conjunction with other blowing agents or on its own.

Typically, physical blowing agents for use in the current invention may be selected from acetone, carbon dioxide, optionally substituted hydrocarbons, and chloro/fluorocarbons. Chloro/fluorocarbons include hydrochlorofluorocarbons, chlorofluorocarbons, fluorocarbons and chlorocarbons. Fluorocarbon blowing agents are typically selected from the group consisting of: difluoromethane, trifluoromethane, fluoroethane, 1,1-difluoroethane, 1,1,1-trifluoroethane, tetrafluoroethanes difluorochloroethane, dichloromono-fluoromethane, 1,1-dichloro-1-fluoroethane, 1,1-difluoro-1,2,2-trichloroethane, chloropentafluoroethane, tetrafluoropropanes, pentafluoropropanes, hexafluoropropanes, heptafluoropropanes, pentafluorobutanes.

Olefin blowing agents may be incorporated, namely trans-1-chloro-3.3.3-trifluoropropene (LBA), trans-1,3,3,3-tetrafluoro-prop-1-ene (HFO-1234ze), 2,3,3,3-tetrafluoro-propene (HFO-1234yf), cis-1,1,1,4,4,4-hexafluoro-2-butene (HFO-1336mzz). Typically, non-halogenated hydrocarbons for use as physical blowing agents may be selected from butane, isobutane, 2,3-dimethylbutane, n- and i-pentane isomers, hexane isomers, heptane isomers and cycloalkanes including cyclopentane, cyclohexane and cycloheptane. More typically, non-halogenated hydrocarbons for use as physical blowing agents may be selected from cyclopentane, iso-pentane and n-pentane.

Typically, where one or more blowing agents are present, they are used in an amount of from about 0 to about 10 parts, more typically 2-6 parts of the total formulation. Where water is used in conjunction with another blowing agent the ratio of the two blowing agents can vary widely, e.g. from 1 to 99 parts by weight of water in total blowing agent, preferably, 25 to 99+ parts by weight water

Preferably, the blowing agent is selected from cyclopentane, iso-pentane, n-pentane. More preferably the blowing agent is n-pentane.

Typical plasticisers may be selected from succinate esters, adipate esters, phthalate esters, diisooctylphthalate (DIOP), benzoate esters and N,N-bis(2-hydroxyethyl)-2-aminoethane sulfonic acid (BES).

Typical flame retardants will be known to those skilled in the art, and may be selected from phosphonamidates, 9,10-dihydro-9-oxa-phosphaphenanthrene-10-oxide (DOPO), chlorinated phosphate esters, Tris(2-chloroisopropyl)phosphate (TCPP), Triethyl phosphate (TEP), tris(chloroethyl) phosphate, tris(2,3-dibromopropyl) phosphate, 2,2-bis(chloromethyl)-1,3-propylene bis(di(2-chloroethyl) phosphate), tris(1,3-dichloropropyl) phosphate, tetrakis(2-chloroethyl) ethylene diphosphate, tricresyl phosphate, cresyl diphenyl phosphate, diammonium phosphate, melamine, melamine pyrophosphate, urea phosphate, alumina, boric acid, various halogenated compounds, antimony oxide, chlorendic acid derivatives, phosphorus containing polyols, bromine containing polyols, nitrogen containing polyols, and chlorinated paraffins. Flame retardants may be present in amounts from 0-60 parts of the total mixture.

The compositions of the invention can further comprise a (poly)isocyanate.

Typically, the (poly)isocyanate comprises two or more isocyanate groups per molecule. Preferably, the (poly)isocyanates are diisocyanates. However, the (poly)isocyanates may be higher (poly)isocyanates such as triisocyanates, tetraisocyanates, isocyanate polymers or oligomers, and the like. The (poly)isocyanates may be aliphatic (poly)isocyanates or derivatives or oligomers of aliphatic (poly)isocyanates or may be aromatic (poly)isocyanates or derivatives or oligomers of aromatic (poly)isocyanates. Typically, the (poly)isocyanate component has a functionality of 2 or more. In some embodiments, the (poly)isocyanate component comprises a mixture of diisocyanates and higher isocyanates formulated to achieve a particular functionality number for a given application.

In some embodiments, the (poly)isocyanate employed has a functionality greater than 2. In some embodiments, such (poly)isocyanates have a functionality between 2 to 5, more typically, 2-4, most typically, 2-3.

Suitable (poly)isocyanates which may be used include aromatic, aliphatic and cycloaliphatic polyisocyanates and combinations thereof. Such polyisocyanates may be selected from the group consisting of: 1,3-Bis(isocyanatomethyl)benzene, 1,3-Bis(isocyanatomethyl)cyclohexane (H6-XDI), 1,4-cyclohexyl diisocyanate, 1,2-cyclohexyl diisocyanate, 1,4-phenylene diisocyanate, 1,3-phenylene diisocyanate, 1,4-tetramethylene diisocyanate, 1,6-hexamethylene diisocyanate, 1,6-hexamethylaminediisocyanate (HDI), isophorone diisocyanate (IPDI), 2,4-toluene diisocyanate (TDI), 2,4,4-trimethylhexamethylene diisocyanate (TMDI), 2,6-toluene diisocyanate (TDI), 4,4′ methylene-bis(cyclohexyl isocyanate) (H12MDI), naphthalene-1,5-diisocyanate, diphenylmethane-2,4′-diisocyanate (MDI), diphenylmethane-4,4′-diisocyanate (MDI), triphenylmethane-4,4′,4triisocyanate, isocyanatomethyl-1,8-octane diisocyanate (TIN), m-tetramethylxylylene diisocyanate (TMXDI), p-tetramethylxylylene diisocyanate (TMXDI), Tris(p-isocyanatomethyl)thiosulfate, trimethylhexane diisocyanate, lysine diisocyanate, m-xylylene diisocyanate (XDI), p-xylylene diisocyanate (XDI), 1,3,5-hexamethyl mesitylene triisocyanate, 1-methoxyphenyl-2,4-diisocyanate, toluene-2,4,6-triisocyanate, 4,4′-biphenylene diisocyanate, 3,3′-dimethyl-4,4′-diphenyl diisocyanate, 4,4′-dimethyldiphenyl methane-2,2′,5,5′-tetraisocyanate and mixtures of any two or more of these. In addition, the (poly)isocyanates may be selected from polymeric version of any of these isocyanates, these may have high or low functionality. Preferred polymeric isocyanates may be selected from MDI. TDI, and polymeric MDI.

According to a still further aspect of the present invention there is provided a polyurethane as defined by the claims.

i.e. a polyurethane produced from the reaction of a polyol block copolymer of the first aspect of the present invention and a (poly)isocyanate. A polyurethane can also be produced from the reaction of a composition according to the second aspect of the present invention and a (poly)isocyanate. The polyurethane may be in the form of a soft foam, a flexible foam, an integral skin foam, a high resilience foam, a viscoelastic or memory foam, a semi-rigid foam, a rigid foam (such as a polyurethane (PUR) foam, a polyisocyanurate (PIR) foam and/or a spray foam), an elastomer (such as a cast elastomer, a thermoplastic elastomer (TPU) or a microcellular elastomer), an adhesive (such as a hot melt adhesive, pressure sensitive or a reactive adhesive), a sealant or a coating (such as a waterborne or solvent dispersion (PUD), a two-component coating, a one component coating, a solvent free coating). The polyurethane may be formed via a process that involves extruding, moulding, injection moulding, spraying, foaming, casting and/or curing. The polyurethane may be formed via a ‘one pot’ or ‘pre-polymer’ process.

The block copolymer residue of the polyurethane may include any one or more features as defined in relation to the first aspect of the invention.

The polyurethanes may also comprise one or more chain extenders, which are typically low molecular polyols, polyamines or compounds with both amine and hydroxyl functionality known in the art. Such chain extenders include ethylene glycol, 1,2-propylene glycol, 1,3-propanediol, 1,4-butanediol, 1,5-pentanediol, 1,6-hexanediol, 1,8-octanediol, 1,10-decanediol, 1,12-dodecanediol, neopentyl glycol, trimethoxypropane (TMP), diethylene glycol, dipropylene glycol, diamines such as ethylenediamine, 1,2-propylenediamine, 1,3-propylenediamine, N-methylpropylene-1,3-diamine, 2,4-tolylenediamine, 2,6 tolylenediamine and diethanolamine.

According to a still further aspect of the present invention there is provided an isocyanate terminated polyurethane prepolymer as defined by the claims. i.e. an isocyanate terminated polyurethane prepolymer comprising the reaction product of the copolymer according to the first aspect of the present invention or the composition of the second aspect of the present invention and an excess of (poly)isocyanate such as at least >1 mole of isocyanate groups per mole OH groups. The isocyanate terminated prepolymer may be formed into a polyurethane via reaction with one or more chain extenders (such as diols, triols, diamines etc) and/or further polyisocyanates and/or other additives.

According to a further aspect, there is provided an isocyanate terminated polyurethane prepolymer comprising a block copolymer residue which may include any one or more features as defined in the first aspect of the invention.

Catalysts that may be added to the (poly)ol block copolymer of the first aspect of the present invention and/or compositions of the second aspect of the present invention may be catalysts for the reaction of (poly)isocyanates and a polyol. These catalysts include suitable urethane catalysts such as tertiary amine compounds and/or organometallic compounds.

Optionally, a trimerisation catalyst may be used. An excess of (poly)isocyanate, or more preferably an excess of polymeric isocyanate relative to polyol may be present so that polyisocyanurate ring formation is possible when in the presence of a trimerisation catalyst. Any of these catalysts may be used in conjunction with one or more other trimerisation catalysts.

According to a still further aspect of the invention, there is provided a lubricant composition comprising a (poly)ol block copolymer according to the first aspect of the present invention.

According to a still further aspect of the invention, there is provided a surfactant composition comprising a (poly)ol block copolymer according to the first aspect of the present invention.

According to a still further aspect of the present invention there is provided a process for producing a (poly)ol block copolymer as defined by the claims.

The process may further comprise a fourth reaction comprising the reaction of the (poly)ol block copolymer of the third reaction with a monomer or further polymer in the absence of a third reaction catalyst to produce a higher polymer.

The monomer or further polymer may be a (poly)isocyanate and the product of the fourth reaction may be a polyurethane.

According to a still further aspect of the present invention there is provided a process for producing a (poly)ol block copolymer in a multiple reactor system as defined by the claims.

Adding the components in the separate reactions and reactors may be useful to increase activity of the catalysts and may lead to a more efficient process, compared with a process in which all of the materials are provided at the start of one reaction. Large amounts of some of the components present throughout the reaction may reduce efficiency of the catalysts. Reacting this material in separate reactors may prevent this reduced efficiency of the catalysts and/or may optimise catalyst activity. The reaction conditions of each reactor can be tailored to optimise the reactions for each catalyst.

Additionally, not loading the total amount of each component at the start of the reaction and having the catalyst for the first and optionally, second reaction in a separate reactor to the catalyst for the third and optionally, second reaction, may lead to even catalysis, and more uniform polymer products. This in turn may lead to polymers having a narrower molecular weight distribution, desired ratio and distribution along the chain of ether to carbonate linkages, and/or improved polyol stability.

Having the reactions with the two different catalysts separate and mixing only certain components in the first and optionally, second reaction and adding the remainder in the third and optionally, second reaction may also be useful as the third reaction catalyst can be pre-activated. Such pre-activation may be achieved by mixing one or both catalysts with epoxide (and optionally other components). Pre-activation of the third reaction catalyst is useful as it enables safe control of the reaction (preventing uncontrolled increase of unreacted monomer content) and removes unpredictable activation periods.

It will be appreciated that the present invention relates to a reaction in which carbonate, ester and ether linkages are added to a growing polymer chain. Having separate reactions allows the first and optionally, second reaction to proceed before a third and optionally, second stage in the reaction, producing controlled block copolymers Mixing epoxide, carbonate catalyst, starter compound and carbon dioxide, may permit growth of a polymer having a high number of carbonate linkages. Thereafter, adding the products to the third reaction catalyst either before or after addition of the ester block permits the reaction to proceed by adding a higher incidence of ether linkages to the growing polymer chain. Ether and ester linkages are more thermally stable than carbonate linkages and less prone to degradation by bases such as the amine catalysts used in PU formation. Therefore, applications get the benefits of high carbonate linkages (such as increased strength, chemical resistance, both oil and hydrolysis resistance etc) that are introduced from the A block whilst retaining the stability of the polyol through the intermediate ester linkages and predominant ether linkages from the C blocks at the ends of the polymer chains. The intermediate ester linkages increase the stability of the final polyol and in particular increase stability of the intermediate polycarbonate polyol during the final (poly)ether or (poly)ether carbonate reaction. This decreases the production of cyclic carbonate by-product, giving improved polyol yields and carbon dioxide incorporation but also enables use of industrially relevant reaction/polymerisation conditions in reaction three, such as above room temperature.

In general terms, an aim of the present invention is to control the polymerisation reaction through a two-reactor system, to increase CO₂ content of the (poly)ol block copolymers at low pressures (enabling more cost effective processes and plant design) and making a product that has high CO₂ content but good stability and application performance. The processes herein may allow the product prepared by such processes to be tailored to the necessary requirements.

The (poly)ol block copolymers of the present invention may be prepared from a suitable epoxide and carbon dioxide in the presence of a starter compound and a carbonate or ether carbonate catalyst for the first reaction; and then the addition of one or more ester linkages in either the first or second reactor by the ester catalyst followed by addition of a suitable epoxide and optionally further carbon dioxide in the presence of an ether catalyst such as a double metal cyanide (DMC) catalyst in the third reaction.

The catalyst for the production of polycarbonate is termed the carbonate catalyst. The catalyst for the production of polyethercarbonate in the first reaction is an ether carbonate catalyst. The catalyst for the production of the (poly)ester block is an ester catalyst. The catalyst for the production of the (poly)ether or (poly)ether carbonate end block is termed the ether catalyst. Suitable catalysts for the production of polyethercarbonate in the first reaction and for the production of the (poly)ester block in the second reaction and for the production of the (poly)ether or (poly)ether carbonate end block in the third reaction may be the same and references to third reaction catalyst may be taken as equally applicable to the second reaction catalyst or ethercarbonate first reaction catalyst unless indicated to the contrary.

The carbonate catalyst may be a catalyst that produces a polycarbonate polyol with greater than 76% carbonate linkages, preferably greater than 80% carbonate linkages, more preferably greater than 85% carbonate linkages, most preferably greater than 90% carbonate linkages and such linkage ranges may accordingly be present in block A.

If the epoxide used is asymmetric (e.g. propylene oxide), the catalyst may produce polycarbonate polyols with a high proportion of head to tall linkages, such as greater than 70%, greater than 80% or greater than 90% head to tail linkages. Alternatively, the catalyst may produce polycarbonate polyols with no stereoselectivity, producing polyols with approximately 50% head to tail linkages.

In preferred embodiments, A (poly)ol block copolymer comprising a polycarbonate block, A (-A′-Z′—Z—(Z′-A′)ₙ-), (poly)ester blocks, B, and (poly)ether blocks, C are provided, wherein the (poly)ol block copolymer has the polyblock structure:

C—B-A′-Z′—Z—(Z′-A′-B—C)ₙ
wherein n=t−1 and wherein t=the number of terminal OH group residues on the block A; and
wherein each A′ is independently a polycarbonate chain having at least 70% carbonate linkages, wherein each B is a (poly)ester chain formed by epoxide and cyclic anhydride reaction/copolymerisation and/or cyclic ester ring-opening reaction/polymerisation, and each C is (poly)ether chain having 50-100%, typically, 60, 70, 80, 90 or 95-100% ether linkages; and
wherein Z′—Z—(Z′)ₙ is a starter residue.

This preferred embodiment may be combined with any of the features of the claims relating to the (poly)ol block copolymer unless such is mutually exclusive.

The carbonate catalyst and the catalyst for the cyclic anhydride/epoxide reaction/copolymerisation or the cyclic ester ring opening reaction/polymerisation may be the same and although termed the carbonate catalyst it may equally be utilised as the ester catalyst.

The carbonate catalyst may be heterogeneous or homogeneous.

The carbonate catalyst may be a mono-metallic, bimetallic or multi-metallic homogeneous complex.

The carbonate catalyst may comprise phenol or phenolate ligands.

Typically, the carbonate catalyst may be a bimetallic complex comprising phenol or phenolate ligands. The two metals may be the same or different.

The carbonate catalyst may be a catalyst of formula (VI):

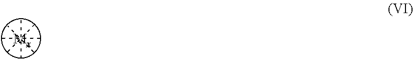

wherein:
M is a metal cation represented by M-(L)ᵥ;
x is an integer from 1 to 4, preferably x is 1 or 2;

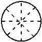

is a multidentate ligand or plurality of multidentate ligands:
L is a coordinating ligand, for example, L may be a neutral ligand, or an anionic ligand, preferably one that is capable of ring-opening an epoxide;
v is an integer that independently satisfies the valency of each M, and/or the preferred coordination geometry of each M or is such that the complex represented by formula (VI) above has an overall neutral charge. For example, each v may independently be 0, 1, 2 or 3, e.g. v may be 1 or 2. When v>1, each L may be different.

The term multidentate ligand includes bidentate, tridentate, tetradentate and higher dentate ligands. Each multidentate ligand may be a macrocyclic ligand or an open ligand.

Such catalysts include those in WO2010022388 (metal salens and derivatives, metal porphyrins, corroles and derivatives, metal tetraaza annulenes and derivatives), WO2010028362 (metal salens and derivatives, metal porphyrins, corroles and derivatives, metal tetraaza annulenes and derivatives), WO2008136591 (metal salens), WO2011105846 (metal salens), WO2014148825 (metal salens), WO2013012895 (metal salens), EP2258745A1 (metal porphyrins and derivatives), JP2008081518A (metal porphyrins and derivatives), CN101412809 (metal salens and derivatives), WO2019126221 (metal aminotriphenol complexes), U.S. Pat. No. 9,018,318 (metal beta-diiminate complexes), U.S. Pat. No. 6,133,402A (metal beta-diiminate complexes) and U.S. Pat. No. 8,278,239 (metal salens and derivatives), the entire contents of which, especially, insofar as they relate to suitable carbonate catalysts for the reaction of CO₂ and alkylene oxide, in the presence of a starter and optionally a solvent to produce a polycarbonate polyol copolymer according to block A are incorporated herein by reference.

Such catalysts also include those in WO2009/130470, WO2013/034750, WO2016/012786, WO2016/012785, WO2012037282 and WO2019048878A1 (all bimetallic phenolate complexes), the entire contents of which, especially, insofar as they relate to suitable carbonate catalysts for the reaction of CO₂ and epoxide, in the presence of a starter and optionally a solvent to produce a polycarbonate polyol copolymer according to block A are incorporated herein by reference.

The carbonate catalyst may have the following structure:

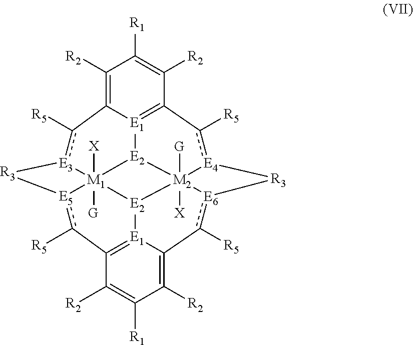

wherein:
M₁ and M₂ are independently selected from Zn(II), Cr(II), Co(II), Cu(II), Mn(II), Mg(II), Ni(II), Fe(II), Ti(II), V(II), Cr(III)-X, Co(III)-X, Mn(III)-X, Ni(III)-X, Fe(III)-X, Ca(II), Ge(II), Al(III)-X, Ti(III)-X, V(III)-X, Ge(IV)-(X)₂, Y(III)-X, Sc(III)-X or Ti(IV)-(X)₂;
R₁ and R₂ are independently selected from hydrogen, halide, a nitro group, a nitrile group, an imine, an amine, an ether, a silyl group, a silyl ether group, a sulfoxide group, a sulfonyl group, a sulfinate group or an acetylide group or an optionally substituted alkyl, alkenyl, alkynyl, haloalkyl, aryl, heteroaryl, alkoxy, aryloxy, alkylthio, arylthio, alicyclic or heteroalicyclic group;
R₃ is independently selected from optionally substituted alkylene, alkenylene, alkynylene, heteroalkylene, heteroalkenylene, heteroalkynylene, arylene, heteroarylene or cycloalkylene, wherein alkylene, alkenylene, alkynylene, heteroalkylene, heteroalkenylene and heteroalkynylene, may optionally be interrupted by aryl, heteroaryl, alicyclic or heteroalicyclic;
R₅ is independently selected from H, or optionally substituted aliphatic, heteroaliphatic, alicyclic, heteroalicyclic, aryl, heteroaryl, alkylheteroaryl or alkylaryl;
E₁ is C, E₂ is O, S or NH or E₁ is N and E₂ is O;
E₃, E₄, E₅ and E₆ are selected from N, NR₄, O and S, wherein when E₃, E₄, E₅ or E₆ are N, [symbol] is [symbol] , and wherein when E₃, E₄, E₅ or E₆ are NR₄, O or S, [symbol] is [symbol] ;
R₄ is independently selected from H, or optionally substituted aliphatic, heteroaliphatic, alicyclic, heteroalicyclic, aryl, heteroaryl, alkylheteroaryl, -alkylC(O)OR₁₉ or -alkylC≡N or alkylaryl;
X is independently selected from OC(O)Rₓ, OSO₂Rₓ, OSORₓ, OSO(Rₓ)₂, S(O)Rₓ, ORₓ, phosphinate, phosphonate, halide, nitrate, hydroxyl, carbonate, amino, nitro, amido or optionally substituted aliphatic, heteroaliphatic, alicyclic, heteroalicyclic, aryl or heteroaryl, wherein each X may be the same or different and wherein X may form a bridge between M₁ and M₂;
Rₓ is independently hydrogen, or optionally substituted aliphatic, haloaliphatic, heteroaliphatic, alicyclic, heteroalicyclic, aryl, alkylaryl or heteroaryl; and
G is absent or independently selected from a neutral or anionic donor ligand which is a Lewis base.

Each of the occurrences of the groups R₁ and R₂ may be the same or different, and R₁ and R₂ can be the same or different.

As mentioned above, the ethercarbonate catalyst for the first reaction and/or the ester catalyst for the cyclic anhydride/epoxide reaction/copolymerisation or the cyclic ester ring opening reaction/polymerisation for the second reaction and/or the ether catalyst for the third reaction may be the same and termed the third reaction catalyst.

The third reaction catalyst may be selected from one or more coordinative, organic, anionic, cationic, metal alkoxide and lewis acid/base pair catalysts.

The third reaction catalyst may more specifically be selected from one or more DMC, metal hydroxide (such as KOH, NaOH, CsOH), superacid (such as HSbF₆, HPF₆, CF₃SO₃H), lewis acidic metal salts (such as Zn(OTf)₂, La(OTf)₃, Y(OTf)₃), Cu(BF₄)₂), group 3 compounds (such as Boron or Aluminium compounds, e.g BF₃, B(C₆F₅)₃, Al(CF₃SO₃)₃), organic (such as imidazole or phosphazonium catalysts), metallosalenates and metal alkoxide (such as Ti(OiPr)₄) catalysts.

A suitable third reaction catalyst i.e. for any one or more of the ethercarbonate in the first reaction and/or for the second reaction and/or for the third reaction is a DMC catalyst. A suitable catalyst for the second reaction is also a carbonate catalyst as defined herein. The second reaction may use the catalyst of either the first reaction or the third reaction or may use an independent catalyst, such as those known for ring-opening reactions of cyclic esters or epoxide/anhydride reaction/copolymerisation. Preferably, the second reaction uses the catalyst of either the first reaction or the third reaction, more preferably, a carbonate catalyst or DMC catalyst.

In some embodiments of the present invention, a process for producing a (poly)ol block copolymer according to the claims comprises a first polymerisation reaction of a carbonate catalyst as defined herein with CO₂ and epoxide, in the presence of a starter and/or solvent to produce a polycarbonate polyol copolymer, a second reaction of the copolymer of the first reaction with epoxide and cyclic anhydride for reaction/copolymerisation in the presence of the said carbonate catalyst to produce a polycarbonate-ester block copolymer and a third reaction/polymerisation reaction of the block copolymer of the second reaction with an epoxide (and optionally, CO₂) in the presence of a DMC catalyst to produce the (poly)ol block copolymer.

A preferred catalyst for the third reaction catalyst is a DMC catalyst.

DMC catalysts are complicated compounds which comprise at least two metal centres and cyanide ligands. The DMC catalyst may additionally comprise at least one of: one or more complexing agents, water, a metal salt and/or an acid (e.g. in non-stoichiometric amounts).

The first two of the at least two metal centres may be represented by M′ and M″.

M′ may be selected from Zn(II), Ru(II), Ru(III), Fe(II), Ni(II), Mn(II), Co(II), Sn(II), Pb(II), Fe(III), Mo(IV), Mo(VI), Al(III), V(V), V(VI), Sr(II), W(IV), W(VI), Cu(II), and Cr(III), M′ is optionally selected from Zn(II), Fe(II), Co(II) and Ni(III) optionally M′ is Zn(II).

M″ is selected from Fe(II), Fe(III), Co(II), Co(III), Cr(II), Cr(III), Mn(II), Mn(III), Ir(III), Ni(II), Rh(III), Ru(II), V(IV), and V(V), optionally M″ is selected from Co(II), Co(III), Fe(II), Fe(III), Cr(III), Ir(III) and Ni(II), optionally M″ is selected from Co(II) and Co(III).

It will be appreciated that the above optional definitions for M′ and M″ may be combined. For example, optionally M′ may be selected from Zn(II), Fe(II), Co(II) and Ni(II), and M″ may optionally be selected from Co(II), Co(II), Fe(II), Fe(III), Cr(III), Ir(III) and Ni(II). For example, M′ may optionally be Zn(II) and M″ may optionally be selected from Co(II) and Co(III).

If a further metal centre(s) is present, the further metal centre may be further selected from the definition of M′ or M″.

Examples of DMC catalysts which can be used in the process of the invention include those described in U.S. Pat. Nos. 3,427,256, 5,536,883, 6,291,388, 6,486,361, 6,608,231, 7,008,900. U.S. Pat. Nos. 5,482,908, 5,780,584, 5,783,513, 5,158,922, 5,693,584, 7,811,958, 6,835,687, 6,699,961, 6,716,788, 6,977,236, 7,968,754, 7,034,103, 4,826,953, 4,500,704, 7,977,501, 9,315,622, EP-A-1568414, EP-A-1529566, and WO 2015/022290, the entire contents of which, especially, insofar as they relate to DMC catalysts for the production of the block copolymer of the first aspect defined herein or the process of production herein, are incorporated herein by reference.

It will be appreciated that the DMC catalyst may comprise:

M′_{d}[M″ₑ(CN)_{f}]_{g}

wherein M′ and M″ are as defined above, d, e, f and g are integers, and are chosen such that the DMC catalyst has electroneutrality. Optionally, d is 3. Optionally, e is 1. Optionally f is 6. Optionally g is 2. Optionally, M′ is selected from Zn(II), Fe(II), Co(II) and Ni(II), optionally M′ is Zn(II). Optionally M″ is selected from Co(II), Co(III), Fe(II), Fe(III), Cr(III), Ir(III) and Ni(II), optionally M″ is Co(II) or Co(III).

It will be appreciated that any of these optional features may be combined, for example, d is 3, e is 1, f is 6 and g is 2, M′ is Zn(II) and M″ is Co(III).

Suitable DMC catalysts of the above formula may include zinc hexacyanocobaltate(III), zinc hexacyanoferrate(III), nickel hexacyanoferrate(II), and cobalt hexacyanocobaltate(III).

There has been a lot of development in the field of DMC catalysts, and the skilled person will appreciate that the DMC catalyst may comprise, in addition to the formula above, further additives to enhance the activity of the catalyst. Thus, while the above formula may form the “core” of the DMC catalyst, the DMC catalyst may additionally comprise stoichiometric or non-stoichiometric amounts of one or more additional components, such as at least one complexing agent, an acid, a metal salt, and/or water.

For example, the DMC catalyst may have the following formula:

M′_{d}[M″ₑ(CN)_{f}]_{g}·hM′″X″ᵢ·jR^{c}·kH₂O·lHᵣX′″

wherein M′, M″, X′″, d, e, f and g are as defined above. M′″ can be M′ and/or M″. X″ is an anion selected from halide, oxide, hydroxide, sulphate, carbonate, cyanide, oxalate, thiocyanate, isocyanate, isothiocyanate, carboxylate and nitrate, optionally X″ is halide. i is an integer of 1 or more, and the charge on the anion X″ multiplied by i satisfies the valency of M′″. r is an integer that corresponds to the charge on the counterion X′″. For example, when X′″ is Cl⁻, r will be 1. l is 0, or a number between 0.1 and 5. Optionally, l is between 0.15 and 1.5.

R^{c} is a complexing agent or a combination of one or more complexing agents. For example, R^{c} may be a (poly)ether, a polyether carbonate, a polycarbonate, a poly(tetramethylene ether diol), a ketone, an ester, an amide, an alcohol (e.g. a C₁₋₈ alcohol), a urea and the like, such as propylene glycol, polypropylene glycol, (m)ethoxy ethylene glycol, dimethoxyethane, tert-butyl alcohol, ethylene glycol monomethyl ether, diglyme, triglyme, methanol, ethanol, isopropyl alcohol, n-butyl alcohol, isobutyl alcohol, sec-butyl alcohol, 3-buten-1-ol, 2-methyl-3-buten-2-ol, 2-methyl-3-butyn-2-ol, 3-methyl-1-pentyn-3-ol or a combination thereof, for example, R^{c} may be tert-butyl alcohol, dimethoxyethane, or polypropylene glycol.

As indicated above, more than one complexing agent may be present in the DMC catalysts used in the present invention. Optionally one of the complexing agents of R_{c} may be a polymeric complexing agent. Optionally, R_{c} may be a combination of a polymeric complexing agent and a non-polymeric complexing agent. Optionally, a combination of the complexing agents tert-butyl alcohol and polypropylene glycol may be present.

It will be appreciated that if the water, complexing agent, acid and/or metal salt are not present in the DMC catalyst, h, j, k and/or l will be zero respectively. If the water, complexing agent, acid and/or metal salt are present, then h, j, k and/or l are a positive number and may, for example, be between 0 and 20. For example, h may be between 0.1 and 4. j may be between 0.1 and 6. k may be between 0 and 20, e.g. between 0.1 and 10, such as between 0.1 and 5. l may be between 0.1 and 5, such as between 0.15 and 1.5.

The polymeric complexing agent is optionally selected from a polyether, a polycarbonate ether, and a polycarbonate. The polymeric complexing agent may be present in an amount of from about 5% to about 80% by weight of the DMC catalyst, optionally in an amount of from about 10% to about 70% by weight of the DMC catalyst, optionally in an amount of from about 20% to about 50% by weight of the DMC catalyst.

The DMC catalyst, in addition to at least two metal centres and cyanide ligands, may also comprise at least one of: one or more complexing agents, water, a metal salt and/or an acid, optionally in non-stoichiometric amounts.

An exemplary DMC catalyst is of the formula Zn₃[Co(CN)₆]₂·hZnCl₂·kH₂O·j[(CH₃)₃COH], wherein h, k and j are as defined above. For example, h may be from 0 to 4 (e.g. from 0.1 to 4), k may be from 0 to 20 (e.g. from 0.1 to 10), and j may be from 0 to 6 (e.g. from 0.1 to 6). As set out above, DMC catalysts are complicated structures, and thus, the above formulae including the additional components is not intended to be limiting. Instead, the skilled person will appreciate that this definition is not exhaustive of the DMC catalysts which are capable of being used in the invention.

The starter compound which may be used in the processes for forming polyols of the present invention comprises at least two groups selected from a hydroxyl group (—OH), a thiol (—SH), an amine having at least one N—H bond (—NHR′), a group having at least one P—OH bond (e.g. —PR′(O)OH, PR′(O)(OH)₂ or —P(O)(OR′)(OH)), or a carboxylic acid group (—C(O)OH).

Thus, the starter compound which may be used in the processes for forming polycarbonate or polyethercarbonate block may be of the formula (IV):

Z [symbol] R^{Z})ₐ (IV) as defined above.

Each reaction may comprise a plurality of starter compounds. The starter compounds for the each reaction may be the same or different. Where there are different starter compounds, there may be different starter compounds in the later reactions, for example wherein the starter compound in the first reaction is a first starter compound, and wherein the third reaction comprises adding the first crude reaction mixture to the second reactor comprising a second starter compound and third reaction catalyst such as double metal cyanide (DMC) catalyst and, optionally, solvent and/or epoxide and/or carbon dioxide. The third reaction of the present invention may be conducted at least about 1 minutes after the second reaction, optionally at least about 5 minutes, optionally at least about 15 minutes, optionally at least about 30 minutes, optionally at least about 1 hour, optionally at least about 2 hours, optionally at least about 5 hours. It will be appreciated that in a continuous reaction these periods are the average period from addition of monomer in the first reactor to transfer of monomer residue into the second reactor.

If polymeric, the starter compound may have a molecular weight of at least about 200 Da or of at most about 1000 Da.

For example, having a molecular weight of about 200 to 1000 Da, optionally about 300 to 700 Da, optionally about 400 Da.

The or each starter compound typically has one or more R^{z} groups, optionally two or more R^{z} groups, optionally three or more, optionally four or more, optionally five or more, optionally six or more, optionally seven or more, optionally eight or more R^{z} groups, particularly wherein R^{z} is hydroxyl.

It will be appreciated that any of the above features may be combined. For example, a may be between 1 and 8 or 2 and 6, each R^{Z} may be —OH, —C(O)OH or a combination thereof, and Z may be selected from alkylene, heteroalkylene, arylene, or heteroarylene.

Exemplary starter compounds for either reaction include diols such as 1,2-ethanediol (ethylene glycol), 1-2-propanediol, 1,3-propanediol (propylene glycol), 1,2-butanediol, 1-3-butanediol, 1,4-butanediol, 1,5-pentanediol, 1,6-hexanediol, 1,8-octanediol, 1,10-decanediol, 1,12-dodecanediol, 1,4-cyclohexanediol, 1,2-diphenol, 1,3-diphenol, 1,4-diphenol, neopentyl glycol, catechol, cyclohexenediol, 1,4-cyclohexanedimethanol, dipropylene glycol, diethylene glycol, tripropylene glycol, triethylene glycol, tetraethylene glycol, polypropylene glycols (PPGs) or polyethylene glycols (PEGs) having an Mn of up to about 1500 g/mol, such as PPG 425, PPG 725, PPG 1000 and the like, triols such as glycerol, benzenetriol, 1,2,4-butanetriol, 1,2,6-hexanetriol, tris(methylalcohol)propane, tris(methylalcohol)ethane, tris(methylalcohol)nitropropane, trimethylol propane, polyethylene oxide triols, polypropylene oxide triols and polyester triols, tetraols such as calix[4]arene, 2,2-bis(methylalcohol)-1,3-propanediol, erythritol, pentaerythritol or polyalkylene glycols (PEGs or PPGs) having 4-OH groups, polyols, such as sorbitol or polyalkylene glycols (PEGs or PPGs) having 5 or more —OH groups, or compounds having mixed functional groups including ethanolamine, diethanolamine, methyldiethanolamine, and phenyldiethanolamine.

For example, the starter compound may be a diol such as 1,2-ethanediol (ethylene glycol), 1-2-propanediol, 1,3-propanediol (propylene glycol), 1,2-butanediol, 1-3-butanediol, 1,4-butanediol, 1,5-pentanediol, 1,6-hexanediol, 1,8-octanediol, 1,10-decanediol, 1,12-dodecanediol, 1,4-cyclohexanediol, 1,2-diphenol, 1,3-diphenol, 1,4-diphenol, neopentyl glycol, catechol, cyclohexenediol, 1,4-cyclohexanedimethanol, poly(caprolactone) diol, dipropylene glycol, diethylene glycol, tripropylene glycol, triethylene glycol, tetraethylene glycol, polypropylene glycols (PPGs) or polyethylene glycols (PEGs) having an Mn of up to about 1500 g/mol, such as PPG 425, PPG 725, PPG 1000 and the like. It will be appreciated that the starter compound may be 1,6-hexanediol, 1,4-cyclohexanedimethanol, 1,12-dodecanediol, poly(caprolactone) diol, PPG 425, PPG 725, or PPG 1000.

Further exemplary starter compounds may include diacids such as oxalic acid, malonic acid, succinic acid, glutaric acid, adipic acid, pimelic acid, suberic acid, azelaic acid, sebacic acid, undecanedioic acid, dodecanedioic acid or other compounds having mixed functional groups such as lactic acid, glycolic acid, 3-hydroxypropanoic acid, 4-hydroxybutanoic acid, 5-hydroxypentanoic acid.

Exemplary monofunctional starter compounds may include substances such as alcohols, phenols, amines, thiols and carboxylic acid, for example, alcohols such as methanol, ethanol, 1- and 2-propanol, 1- and 2-butanol, linear or branched C₃-C₂₀-monoalcohol such as tert-butanol, 3-buten-1-ol, 3-butyn-1-ol, 2-methyl-3-buten-2-ol, 2-methyl-3-butyn-2-ol, propargyl alcohol, 2-methyl-2-propanol, 1-tert-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, 1-decanol, 1-dodecanol; phenol, 2-hydroxybiphenyl, 3-hydroxybiphenyl, 4-hydroxybiphenyl, 2-hydroxypyridine, 3-hydroxypyridine, and 4-hydroxypyridine, mono-ethers or esters of ethylene, propylene, polyethylene, polypropylene glycols such as ethylene glycol mono-methyl ether and propylene glycol mono-methyl ether, phenols such as linear or branched C₃-C₂₀ alkyl substituted phenols, for example nonyl-phenols or octyl phenols, monofunctional carboxylic acids such as formic acid, acetic acid, propionic acid and butyric acid, fatty acids, such as stearic acid, palmitic acid, oleic acid, linoleic acid, linolenic acid, benzoic acid and acrylic acid, and monofunctional thiols such as ethanethiol, propane-1-thiol, propane-2-thiol, butane-1-thiol, 3-methylbutane-1-thiol, 2-butene-1-thiol, and thiophenol, or amines such as butylamine, tert-butylamine, pentylamine, hexylamine, aniline, aziridine, pyrrolidine, piperidine, and morpholine

For example, the starter compound may be a monofunctional alcohol such as ethanol, 1-propanol, 2-propanol, 1-butanol, 2-butanol, 1-hexanol, 1-octanol, 1-decanol, 1-dodecanol, a phenol such as nonyl-phenol or octyl phenol or a mono-functional carboxylic acid such as formic acid, acetic acid, propionic acid, butyric acid, fatty acids, such as stearic acid, palmitic acid, oleic acid, linoleic acid, linolenic acid, benzoic acid, acrylic acid.

The ratio of the starter compound, if present, to the carbonate catalyst may be in amounts of from about 1000:1 to about 1:1, for example, from about 750:1 to about 5:1, such as from about 500:1 to about 10:1, e.g. from about 250:1 to about 20:1, or from about 125:1 to about 30:1, or from about 50:1 to about 20:1. These ratios are molar ratios. These ratios are the ratios of the total amount of starter to the total amount of the carbonate catalyst used in the processes. These ratios may be maintained during the course of addition of materials. If the carbonate or ether carbonate catalyst used for reaction 1 is a heterogeneous catalyst, such as a DMC catalyst, then the ratio of catalyst to starter material will be a mass ratio.

The third reaction catalyst for the production of a block copolymer according to the aspects herein may be pre-activated. Optionally, the third reaction catalyst may be pre-activated in reactor 2 or separately. Optionally, the third reaction catalyst may be pre-activated with a starter compound or with the polycarbonate or ether carbonate polyol copolymer according to block A of the first aspect or with the reaction product of the first and/or second and/or third reaction. When the third reaction catalyst is pre-activated with the reaction product of the first and/or second and/or third reaction, it may be pre-activated with some or all of the reaction product of the first and optionally second and/or third reaction. The third reaction catalyst may be pre-activated with the (poly)ol block copolymer of the first aspect, C—B-A′-Z′—Z—(Z′-A′-B—C)ₙ which may be added into the reactor, or may be the remaining product from a previous reaction, the so-called ‘reaction heel’.

The (poly)ol block copolymer according to the process of production may be according to one or more features of the first aspect of the invention,

The product of the first reaction may be a low molecular weight polycarbonate or ether carbonate polyol. The preferred molecular weight (Mn) of the polycarbonate or ether carbonate polyol depends on the preferred overall molecular weight of the (poly)ol block copolymer. The molecular weight (Mn) of the polycarbonate or ether carbonate polyol may be in the range from about 200 to about 4000 Da, from about 200 to about 2000 Da, from about 200 to about 1000 Da, or from about 400 to about 800 Da, as measured by Gel Permeation Chromatography.

The first reaction may produce a generally alternating polycarbonate or ether carbonate polyol product.

The polycarbonate or ether carbonate according to block A of the first aspect or the product of the first and optionally second reaction may be fed into the separate reactor containing a pre-activated third reaction catalyst. The first and optionally, second product may be fed into the separate reactor as a crude reaction mixture.

The first reaction of the present invention may be carried out under CO₂ pressure of less than 20 bar, preferably less than 10 bar, more preferably less than 8 bar of CO₂ pressure. The second reaction of the present invention may be carried out under CO₂ pressures of less than 20 bar, preferably less than 10 bar, more preferably less than 8 bar of CO₂ pressure. The third reaction of the present invention may be carried out under CO₂ pressure of less than 60 bar, preferably less than 20 bar, more preferably less than 10 bar, most preferably less than 5 bar of CO₂ pressure.

The CO₂ may be added continuously in the first reaction, preferably in the presence of a starter.

The reactions may be carried out at a pressure of between about 1 bar and about 60 bar carbon dioxide, optionally about 1 bar and about 40 bar, optionally about 1 bar and about 20 bar, optionally between about 1 bar and about 15 bar, optionally about 1 bar and about 10 bar, optionally about 1 bar and about 5 bar.

The second and/or third reactions may be carried out under CO₂, a mixture of CO₂ and an inert gas such as N₂ or Ar or under an inert gas such as N₂ or Ar in the absence of CO₂.

The CO₂ may be introduced into either reactor via standard methods, such as directly into the headspace or directly into the reaction liquid via standard methods such as a inlet tube, gassing ring or a hollow shaft stirrer. The mixing may be optimised by using different configurations of stirrer, such as single agitators or agitators configured in multiple stages.

The first reaction process being carried out under these relatively low CO₂ pressures and the CO₂ added continuously can produce a polyol with high CO₂ content, under low pressure.

The first and, optionally second reaction may be carried out in a batch, semi-batch or continuous process. In a batch process, all the carbonate or ether carbonate catalyst, epoxide, CO₂, starter and optionally solvent are present at the beginning of the reaction. In a semi-batch or continuous reaction, one or more of the carbonate or ether carbonate catalyst, epoxide, CO₂, starter and/or solvent are added into the reactor in a continuous, semi-continuous or discontinuous manner.

The third reaction comprising third reaction catalyst may be carried out as a continuous process or a semi-batch process. In a semi-batch or continuous process one or more of the third reaction catalyst, epoxide, CO₂, starter and/or solvent is added into the reaction in a continuous, semi-continuous or discontinuous manner.

Optionally, the crude reaction mixture fed into the second reactor may include an amount of unreacted epoxide and/or CO₂ and or starter.

Optionally, the crude reaction mixture feed may include an amount of carbonate or ether carbonate catalyst. Optionally, the carbonate or ether carbonate catalyst may have been removed prior to the addition to the second reactor.

The polycarbonate or ether carbonate or ester end capped product of the first and optionally, second reaction may be fed into the second reactor in a single portion or in a continuous, semi-continuous or discontinuous manner, optionally comprising unreacted epoxide and/or carbonate or ether carbonate catalyst. Preferably, the product of the first and optionally second reaction is fed into the second reactor in a continuous manner. This is advantageous as the continuous addition of the product of reaction ½ as a starter for the third reaction catalyst allows the third reaction catalyst in reactor 2 to operate in a more controlled manner as the ratio of starter to third reaction catalyst is always reduced in the reactor. This may prevent deactivation of the third reaction catalyst in reactor 2. The polycarbonate or ether carbonate polyol copolymer according to block A of the first aspect or the polycarbonate or ether carbonate of reaction 1 or optionally the copolymer of block B-A′-Z′—Z—(Z-A′-B)ₙ may be fed into the second reactor prior to activation and may be used during the activation. The third reaction catalyst may also be pre-activated with the (poly)ol block copolymer of the first aspect, C—B-A′-Z′—Z—(Z′-A′-B—C)ₙ which may be added into the reactor, or may be the remaining product from a previous reaction, the so-called ‘reaction heel’. The temperature of the reaction in the first reactor may be in the range of from about 0° C. to 250° C., preferably from about 40° C. to about 160° C., more preferably from about 50° C. to 120° C.

The temperature of the reaction in the second reactor may be in the range from about 50 to about 160° C., preferably in the range from about 70 to about 140° C., more preferably from about 70 to about 110° C.

The two reactors may be located in a series, or the reactors may be nested. Each reactor may individually be a stirred tank reactor, a loop reactor, a tube reactor or other standard reactor design.

Preferably, reaction 3 is run in a continuous mode.

The product of the first or second reaction may be stored for subsequent later use in the second reactor.

Advantageously, the three reactions can be run independently to get optimum conditions for each. If the two reactors are nested they may be effective to provide different reaction conditions to each other simultaneously.

Optionally, the polycarbonate or ether carbonate polyol may have been partially stabilised by an acid prior to addition to the second reactor if reactions 2 and 3 occur in the second reactor. The acid may be an inorganic or an organic acid. Such acids include, but are not limited to, phosphoric acid derivatives, sulfonic acid derivatives (e.g. methanesulfonic acid, p-toluenesulfonic acid), carboxylic acids (e.g. acetic acid, formic acid, oxalic acid, salicylic acid), mineral acids (e.g. hydrochloric acid, hydrobromic acid, hydroiodic acid), nitric acid or carbonic acid. The acid may be part of an acidic resin, such as an ion exchange resin. Acidic ion exchange resins may be in the form of a polymeric matrix (such as polystyrene or polymethacrylic acid) featuring acidic sites such as strong acidic sites (e.g. sulfonic acid sites) or weak acid sites (e.g. carboxylic acid sites). Example ionic exchange resins include Amberlyst 15, Dowex Marathon MSC and Amberlite IRC 748. Alternatively, acidic solids such as silicas, aluminas, zeolites or clays may be used.

The first, second and third reactions of the present invention may be carried out in the presence of a solvent, however it will also be appreciated that the processes may also be carried out in the absence of a solvent. When a solvent is present, it may be toluene, hexane, t-butyl acetate, diethyl carbonate, dimethyl carbonate, dioxane, dichlorobenzene, methylene chloride, propylene carbonate, ethylene carbonate, acetone, ethyl acetate, propyl acetate, n-butyl acetate, tetrahydrofuran (THF), etc. The solvent may be toluene, hexane, acetone, ethyl acetate and n-butyl acetate.

The solvent may act to dissolve one or more of the materials. However, the solvent may also act as a carrier, and be used to suspend one or more of the materials in a suspension. Solvent may be required to aid addition of one or more of the materials during the steps of the processes of the present invention.

The process may employ a total amount of solvent, and wherein about 1 to 100% of the total amount of solvent may be mixed in the first and optionally, second reaction, with the remainder added in the third and optionally, second reaction; optionally with about 1 to 75% being mixed in the first and optionally, second reaction, optionally with about 1 to 50%, optionally with about 1 to 40%, optionally with about 1 to 30%, optionally with about 1 to 20%, optionally with about 5 to 20%.

The total amount of the carbonate or ether carbonate catalyst may be low, such that the first and optionally, second reaction of the invention may be carried out at low catalytic loading. For example, the catalytic loading of the carbonate catalyst may be in the range of about 1:500-100,000 [total carbonate catalyst]:[total epoxide], such as about 1:750-50,000 [total carbonate catalyst]:[total epoxide], e.g. In the region of about 1:1,000-20,000 [total carbonate catalyst]:[total epoxide], for example in the region of about 1:10,000 [total carbonate catalyst]:[total epoxide]. The ratios above are molar ratios. These ratios are the ratios of the total amount of carbonate catalyst to the total amount of epoxide used in the first and optionally, second reaction.

If a DMC catalyst is used to produce an ether carbonate in the first reaction, it would typically be used in the range of 5 to 1000 ppmw compared to the final polyol product.

The process may employ a total amount of carbon dioxide, and about 1 to 100% of the total amount of carbon dioxide incorporated may be in block A. The remainder may be in block B; with optionally about 1 to 75% being incorporated into block A, optionally with about 1 to 50%, optionally with about 1 to 40%, optionally with about 1 to 30%, optionally with about 1 to 20%, optionally with about 5 to 20% being incorporated into block A.

The process may employ a total amount of epoxide, and about 1 to 100% of the total amount of epoxide may be incorporated into block A. The remainder of epoxide may be incorporated into block B; with optionally about 5 to 90% being incorporated into block A, optionally with about 10 to 90%, optionally with about 20 to 90%, optionally with about 40 to 90%, optionally with about 40 to 80%, optionally with about 5 to 50% being incorporated into block A.

The one or more epoxide which is used in the reactions may be any suitable compound containing an epoxide moiety. Exemplary epoxides include ethylene oxide, propylene oxide, butylene oxide and cyclohexene oxide. The epoxide used in the second reactor may be the same or different from the epoxide used in the first reactor. A mixture of one or more epoxides may be present in one or both of the reactors. For example, the first and optionally, second reaction may use ethylene oxide and the third and optionally, second reaction may use propylene oxide, or both reactions may use propylene oxide, or one or both reactions may use a mixture of epoxides such as a mixture of propylene oxide and ethylene oxide. Preferably, propylene oxide and/or ethylene oxide is used in one or both reactors.

The epoxide may be purified (for example by distillation, such as over calcium hydride) prior to reaction with carbon dioxide. For example, the epoxide may be distilled prior to being added.

Examples of epoxides which may be used in the present invention include, but are not limited to, cyclohexene oxide, styrene oxide, ethylene oxide, propylene oxide, butylene oxide, substituted cyclohexene oxides (such as limonene oxide, C₁₀H₁₆O or 2-(3,4-epoxycyclohexyl)ethyltrimethoxysilane, C₁₁H₂₂O), alkylene oxides (such as ethylene oxide and substituted ethylene oxides), unsubstituted or substituted oxiranes (such as oxirane, epichlorohydrin, 2-(2-methoxyethoxy)methyl oxirane (MEMO), 2-(2-(2-methoxyethoxy)ethoxy)methyl oxirane (ME2MO), 2-(2-(2(2-methoxyethoxy)ethoxy)ethoxy)methyl oxirane (ME3MO), 1,2-epoxybutane, glycidyl ethers, glycidyl esters, glycidyl carbonates, vinyl-cyclohexene oxide, 3-phenyl-1,2-epoxypropane, 2,3-epoxybutane, isobutylene oxide, cyclopentene oxide, 2,3-epoxy-1,2,3,4-tetrahydronaphthalene, indene oxide, and functionalized 3,5-dioxaepoxides. Examples of functionalized 3,5-dioxaepoxides include:

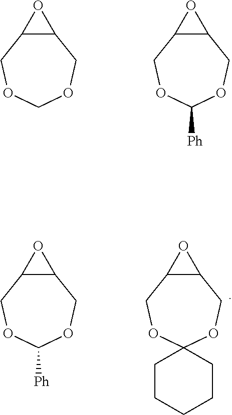

The epoxide moiety may be a glycidyl ether, glycidyl ester or glycidyl carbonate. Examples of glycidyl ethers, glycidyl esters glycidyl carbonates include:

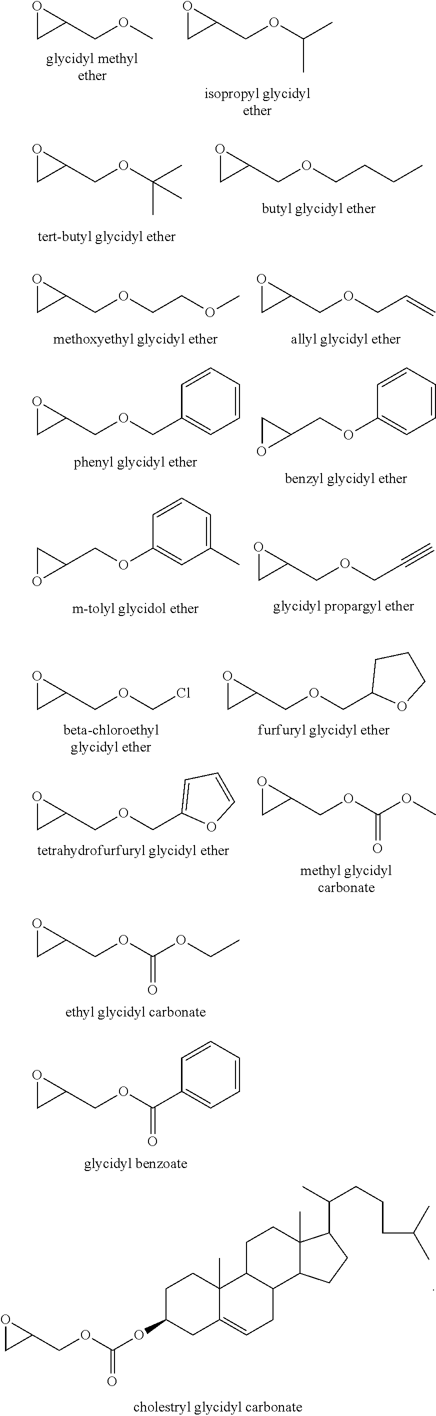

As noted above, the epoxide substrate may contain more than one epoxide moiety, i.e. it may be a bis-epoxide, a tris-epoxide, or a multi-epoxide containing moiety. Examples of compounds including more than one epoxide moiety include, bis-epoxybutane, bis-epoxyoctane, bis-epoxydecane, bisphenol A diglycidyl ether and 3,4-epoxycyclohexylmethyl-3′,4′-epoxycyclohexanecarboxylate. It will be understood that reactions carried out in the presence of one or more compounds having more than one epoxide moiety may lead to cross-linking in the resulting polymer.

Optionally, between 0.1 and 20% of the total epoxide in the first and optionally, second reaction may be an epoxide substrate containing more than one epoxide moiety. Preferably, the multi-epoxide substrate is a bis-epoxide.

The skilled person will appreciate that the epoxide can be obtained from “green” or renewable resources. The epoxide may be obtained from a (poly)unsaturated compound, such as those deriving from a fatty acid and/or terpene, obtained using standard oxidation chemistries.

The epoxide moiety may contain —OH moieties, or protected —OH moieties. The —OH moieties may be protected by any suitable protecting group. Suitable protecting groups include methyl or other alkyl groups, benzyl, allyl, tert-butyl, tetrahydropyranyl (THP), methoxymethyl (MOM), acetyl (C(O)alkyl), benzolyl (C(O)Ph), dimethoxytrityl (DMT), methoxyethoxymethyl (MEM), p-methoxybenzyl (PMB), trityl, silyl (such as trimethylsilyl (TMS), t-butyldimethylsilyl (TBDMS), t-butyldiphenylsilyl (TBDPS), tri-iso-propylsilyloxymethyl (TOM), and triisopropylsilyl (TIPS)), (4-methoxyphenyl)diphenylmethyl (MMT), tetrahydrofuranyl (THF), and tetrahydropyranyl (THP).

The epoxide optionally has a purity of at least 98%, optionally >99%.

The rate at which the materials are added may be selected such that the temperature of the (exothermic) reactions does not exceed a selected temperature (i.e. that the materials are added slowly enough to allow any excess heat to dissipate such that the temperature of the remains approximately constant). The rate at which the materials are added may be selected such that the epoxide concentration does not exceed a selected epoxide concentration.

The process may produce a polyol with a polydispersity between 1.0 and 2.0, preferably between 1.0 and 1.8, more preferably between 1.0 and 1.5, most preferably between 1.0 and 1.3.

The process may comprise mixing third reaction catalyst, epoxide, starter and optionally carbon dioxide and/or cyclic anhydride and/or cyclic ester and/or solvent to form a pre-activated mixture and adding the pre-activated mixture to the second reactor either before or after the crude reaction mixture of the first and optionally, second reaction, to form the third and optionally, second reaction mixture. However, this may take place continuously so that the pre-activated mixture is added at the same time as the crude reaction mixture. The pre-activated mixture may also be formed in the second reactor by mixing the third reaction catalyst, epoxide, starter and optionally carbon dioxide and/or cyclic anhydride and/or cyclic ester and/or solvent. The pre-activation may occur at a temperature of about 50° C. to 160° C., preferably between about 70° C. to 140° C., more preferably about 90° C. to 140° C. The pre-activated mixture may be mixed at a temperature of between about 50 to 160° C. prior to contact with the crude reaction mixture, optionally between about 70 to 140° C.

In the overall reaction process, the amount of said carbonate or ether carbonate catalyst (and second reaction catalyst) and the amount of said (second and)third reaction catalyst may be at a predetermined weight ratio of from about 300:1 to about 1:100 to one another, for example, from about 120:1 to about 1:75, such as from about 40:1 to about 1:50, e.g. from about 30:1 to about 1:30 such as from about 20:1 to about 1:1, for example from about 10:1 to about 2:1, e.g. from about 5:1 to about 1:5. The processes of the present invention can be carried out on any scale. The process may be carried out on an industrial scale. As will be understood by the skilled person, catalytic reactions are generally exothermic. The generation of heat during a small-scale reaction is unlikely to be problematic, as any increase in temperature can be controlled relatively easily by, for example, the use of an ice bath. With larger scale reactions, and particularly industrial scale reactions, the generation of heat during a reaction can be problematic and potentially dangerous. Thus, the gradual addition of materials may allow the rate of the catalytic reaction to be controlled and can minimise the build-up of excess heat. The rate of the reaction may be controlled, for example, by adjusting the flow rate of the materials during addition. Thus, the processes of the present invention have particular advantages if applied to large, industrial scale catalytic reactions.

The temperature may increase or decrease during the course of the processes of the invention.

The amount of said carbonate or ether carbonate catalyst, second reaction catalyst and third reaction catalyst will vary depending on which catalyst used.

### Methods

### Gel Permeation Chromatography

GPC measurements were carried out against narrow polydispersity poly(ethylene glycol) or polystyrene standards in THF using an Agilent 1260 Infinity machine equipped with Agilent PLgel Mixed-D columns.

### Definitions

For the purpose of the present invention, an aliphatic group is a hydrocarbon moiety that may be straight chain (i.e. unbranched) branched, or cyclic and may be completely saturated, or contain one or more units of unsaturation, but which is not aromatic. The term “unsaturated” means a moiety that has one or more double and/or triple bonds. The term “aliphatic” is therefore intended to encompass alkyl, cycloalkyl, alkenyl cycloalkenyl, alkynyl or cycloalkenyl groups, and combinations thereof.

An aliphatic group is optionally a C₁₄₀ aliphatic group, that is, an aliphatic group with 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30 carbon atoms. Optionally, an aliphatic group is a C₁₋₁₅aliphatic, optionally a C₁₋₁₂aliphatic, optionally a C₁₋₁₀aliphatic, optionally a C₁₋₈aliphatic, such as a C₁₋₆aliphatic group. Suitable aliphatic groups include linear or branched, alkyl, alkenyl and alkynyl groups, and mixtures thereof such as (cycloalkyl)alkyl groups, (cycloalkenyl)alkyl groups and (cycloalkyl)alkenyl groups.

The term “alkyl,” as used herein, refers to saturated, straight- or branched-chain hydrocarbon radicals derived by removal of a single hydrogen atom from an aliphatic moiety. An alkyl group is optionally a “C₁₋₂₀ alkyl group”, that is an alkyl group that is a straight or branched chain with 1 to 20 carbons. The alkyl group therefore has 1, 2, 3, 4, 5, 6, 7, 8, 9, 10, 11, 12, 13, 14, 15, 16, 17, 18, 19 or 20 carbon atoms. Optionally, an alkyl group is a C₁₋₁₅ alkyl, optionally a C₁₋₁₂ alkyl, optionally a C₁₋₁₀ alkyl, optionally a C₁₋₈ alkyl, optionally a C₁₋₆ alkyl group. Specifically, examples of “C₁₋₂₀ alkyl group” Include methyl group, ethyl group, n-propyl group, iso-propyl group, n-butyl group, iso-butyl group, sec-butyl group, tert-butyl group, sec-pentyl, iso-pentyl, n-pentyl group, neopentyl, n-hexyl group, sec-hexyl, n-heptyl group, n-octyl group, n-nonyl group, n-decyl group, n-undecyl group, n-dodecyl group, n-tridecyl group, n-tetradecyl group, n-pentadecyl group, n-hexadecyl group, n-heptadecyl group, n-octadecyl group, n-nonadecyl group, n-eicosyl group, 1,1-dimethylpropyl group, 1,2-dimethylpropyl group, 2,2-dimethylpropyl group, 1-ethylpropyl group, n-hexyl group, 1-ethyl-2-methylpropyl group, 1,1,2-trimethylpropyl group, 1-ethylbutyl group, 1-methylbutyl group, 2-methylbutyl group, 1,1-dimethylbutyl group, 1,2-dimethylbutyl group, 2,2-dimethylbutyl group, 1,3-dimethylbutyl group, 2,3-dimethylbutyl group, 2-ethylbutyl group, 2-methylpentyl group, 3-methylpentyl group and the like.

The term “alkenyl,” as used herein, denotes a group derived from the removal of a single hydrogen atom from a straight- or branched-chain aliphatic moiety having at least one carbon-carbon double bond. The term “alkynyl,” as used herein, refers to a group derived from the removal of a single hydrogen atom from a straight- or branched-chain aliphatic moiety having at least one carbon-carbon triple bond. Alkenyl and alkynyl groups are optionally “C₂₋₂₀alkenyl” and “C₂₋₂₀alkynyl”, optionally “C₂₋₁₅ alkenyl” and “C₂₋₁₅ alkynyl”, optionally “C₂₋₁₂ alkenyl” and “C₂₋₁₂ alkynyl”, optionally “C₂₋₁₀ alkenyl” and “C₂₋₁₀ alkynyl”, optionally “C₂₋₈ alkenyl” and “C₂₋₈ alkynyl”, optionally “C₂₋₆ alkenyl” and “C₂₋₆ alkynyl” groups, respectively. Examples of alkenyl groups include ethenyl, propenyl, allyl, 1,3-butadienyl, butenyl, 1-methyl-2-buten-1-yl, allyl, 1,3-butadienyl and allenyl. Examples of alkynyl groups include ethynyl, 2-propynyl (propargyl) and 1-propynyl.

The terms “cycloaliphatic”, “carbocycle”, or “carbocyclic” as used herein refer to a saturated or partially unsaturated cyclic aliphatic monocyclic or polycyclic (including fused, bridging and spiro-fused) ring system which has from 3 to 20 carbon atoms, that is an alicyclic group with 3, 4, 5, 6, 7, 8, 9, 10, 11, 12, 13, 14, 15, 16, 17, 18, 19 or 20 carbon atoms. Optionally, an alicyclic group has from 3 to 15, optionally from 3 to 12, optionally from 3 to 10, optionally from 3 to 8 carbon atoms, optionally from 3 to 6 carbons atoms. The terms “cycloaliphatic”, “carbocycle” or “carbocyclic” also include aliphatic rings that are fused to one or more aromatic or nonaromatic rings, such as tetrahydronaphthyl rings, where the point of attachment is on the aliphatic ring. A carbocyclic group may be polycyclic, e.g. bicyclic or tricyclic. It will be appreciated that the alicyclic group may comprise an alicyclic ring bearing one or more linking or non-linking alkyl substituents, such as —CH₂-cyclohexyl. Specifically, examples of carbocycles include cyclopropane, cyclobutane, cyclopentane, cyclohexane, bicycle[2,2,1]heptane, norbornene, phenyl, cyclohexene, naphthalene, spiro[4.5]decane, cycloheptane, adamantane and cyclooctane.

A heteroaliphatic group (including heteroalkyl, heteroalkenyl and heteroalkynyl) is an aliphatic group as described above, which additionally contains one or more heteroatoms. Heteroaliphatic groups therefore optionally contain from 2 to 21 atoms, optionally from 2 to 16 atoms, optionally from 2 to 13 atoms, optionally from 2 to 11 atoms, optionally from 2 to 9 atoms, optionally from 2 to 7 atoms, wherein at least one atom is a carbon atom. Optional heteroatoms are selected from O, S, N, P and Si. When heteroaliphatic groups have two or more heteroatoms, the heteroatoms may be the same or different. Heteroaliphatic groups may be substituted or unsubstituted, branched or unbranched, cyclic or acyclic, and include saturated, unsaturated or partially unsaturated groups.

An alicyclic group is a saturated or partially unsaturated cyclic aliphatic monocyclic or polycyclic (including fused, bridging and spiro-fused) ring system which has from 3 to 20 carbon atoms, that is an alicyclic group with 3, 4, 5, 6, 7, 8, 9, 10, 11, 12, 13, 14, 15, 16, 17, 18, 19 or 20 carbon atoms. Optionally, an alicyclic group has from 3 to 15, optionally from 3 to 12, optionally from 3 to 10, optionally from 3 to 8 carbon atoms, optionally from 3 to 6 carbons atoms. The term “alicyclic” encompasses cycloalkyl, cycloalkenyl and cycloalkynyl groups. It will be appreciated that the alicyclic group may comprise an alicyclic ring bearing one or more linking or non-linking alkyl substituents, such as —CH₂— cyclohexyl. Specifically, examples of the C₃₋₂₀ cycloalkyl group include cyclopropyl, cyclobutyl, cyclopentyl, cyclohexyl, cycloheptyl, adamantyl and cyclooctyl.

A heteroalicyclic group is an alicylic group as defined above which has, in addition to carbon atoms, one or more ring heteroatoms, which are optionally selected from O, S, N, P and Si. Heteroalicyclic groups optionally contain from one to four heteroatoms, which may be the same or different. Heteroalicyclic groups optionally contain from 5 to 20 atoms, optionally from 5 to 14 atoms, optionally from 5 to 12 atoms.

An aryl group or aryl ring Is a monocyclic or polycyclic ring system having from 5 to 20 carbon atoms, wherein at least one ring in the system is aromatic and wherein each ring in the system contains three to twelve ring members. The term “aryl” can be used alone or as part of a larger moiety as in “aralkyl”, “aralkoxy”, or “aryloxyalkyl”. An aryl group is optionally a “C₆₋₁₂ aryl group” and is an aryl group constituted by 6, 7, 8, 9, 10, 11 or 12 carbon atoms and includes condensed ring groups such as monocyclic ring group, or bicyclic ring group and the like. Specifically, examples of “C₆₋₁₀ aryl group” include phenyl group, biphenyl group, Indenyl group, anthracyl group, naphthyl group or azulenyl group and the like. It should be noted that condensed rings such as indan, benzofuran, phthalimide, phenanthridine and tetrahydro naphthalene are also included in the aryl group.

The term “heteroaryl” used alone or as part of another term (such as “heteroaralkyl”, or “heteroaralkoxy”) refers to groups having 5 to 14 ring atoms, optionally 5, 6, or 9 ring atoms; having 6, 10, or 14 w electrons shared in a cyclic array; and having, in addition to carbon atoms, from one to five heteroatoms. The term “heteroatom” refers to nitrogen, oxygen, or sulfur, and includes any oxidized form of nitrogen or sulfur, and any quaternized form of nitrogen. The term “heteroaryl” also includes groups in which a heteroaryl ring is fused to one or more aryl, cycloaliphatic, or heterocyclyl rings, where the radical or point of attachment is on the heteroaromatic ring. Examples include indolyl, isoindolyl, benzothienyl, benzofuranyl, dibenzofuranyl, indazolyl, benzimidazolyl, benzthiazolyl, quinolyl, isoquinolyl, cinnolinyl, phthalazinyl, quinazolinyl, quinoxalinyl, 4H-quinolizinyl, carbazolyl, acridinyl, phenazinyl, phenothiazinyl, phenoxazinyl, tetrahydroquinolinyl, tetrahydroisoquinolinyl, and pyrido[2,3-b]-1,4-oxazin-3(4H)-one. Thus, a heteroaryl group may be mono- or polycyclic.

The term “heteroaralkyl” refers to an alkyl group substituted by a heteroaryl, wherein the alkyl and heteroaryl portions independently are optionally substituted.

As used herein, the terms “heterocycle”, “heterocyclyl”, “heterocyclic radical”, and “heterocyclic ring” are used interchangeably and refer to a stable 5- to 7-membered monocyclic or 7-14-membered bicyclic heterocyclic moiety that is saturated, partially unsaturated, or aromatic and having, in addition to carbon atoms, one or more, optionally one to four, heteroatoms, as defined above. When used in reference to a ring atom of a heterocycle, the term “nitrogen” includes a substituted nitrogen.

Examples of alicyclic, heteroalicyclic, aryl and heteroaryl groups include but are not limited to cyclohexyl, phenyl, acridine, benzimidazole, benzofuran, benzothiophene, benzoxazole, benzothiazole, carbazole, cinnoline, dioxin, dioxane, dioxolane, dithiane, dithiazine, dithiazole, dithiolane, furan, imidazole, imidazoline, Imidazolidine, indole, indoline, indolizine, Indazole, isoindole, isoquinoline, isoxazole, isothiazole, morpholine, napthyridine, oxazole, oxadiazole, oxathiazole, oxathiazolidine, oxazine, oxadiazine, phenazine, phenothiazine, phenoxazine, phthalazine, piperazine, piperidine, pteridine, purine, pyran, pyrazine, pyrazole, pyrazoline, pyrazolidine, pyridazine, pyridine, pyrimidine, pyrrole, pyrrolidine, pyrroline, quinoline, quinoxaline, quinazoline, quinolizine, tetrahydrofuran, tetrazine, tetrazole, thiophene, thiadiazine, thiadiazole, thiatriazole, thiazine, thiazole, thiomorpholine, thianaphthalene, thiopyran, triazine, triazole, and trithiane.

The term “halide”, “halo” and “halogen” are used interchangeably and, as used herein mean a fluorine atom, a chlorine atom, a bromine atom, an iodine atom and the like, optionally a fluorine atom, a bromine atom or a chlorine atom, and optionally a fluorine atom.

A haloalkyl group is optionally a “C₁₋₂₀ haloalkyl group”, optionally a “C₁₋₁₅ haloalkyl group”, optionally a “C₁₋₁₂ haloalkyl group”, optionally a “C₁₋₁₀ haloalkyl group”, optionally a “C₁₋₈ haloalkyl group”, optionally a “C₁₋₆ haloalkyl group” and is a C₁₋₂₀ alkyl, a C₁₋₁₅ alkyl, a C₁₋₁₂ alkyl, a C₁₋₁₀ alkyl, a C₁₋₈ alkyl, or a C₁₋₆ alkyl group, respectively, as described above substituted with at least one halogen atom, optionally 1, 2 or 3 halogen atom(s). The term “haloalkyl” encompasses fluorinated or chlorinated groups, Including perfluorinated compounds. Specifically, examples of “C₁₋₂₀ haloalkyl group” include fluoromethyl group, difluoromethyl group, trifluoromethyl group, fluoroethyl group, difluoroethyl group, trifluoroethyl group, chloromethyl group, bromomethyl group, iodomethyl group and the like.

The term “acyl” as used herein refers to a group having a formula —C(O)R where R is hydrogen or an optionally substituted aliphatic, aryl, or heterocyclic group.

An alkoxy group is optionally a “C₁₋₂₀ alkoxy group”, optionally a “C₁₋₁₅ alkoxy group”, optionally a “C₁₋₁₂ alkoxy group”, optionally a “C₁₋₁₀ alkoxy group”, optionally a “C₁₋₈ alkoxy group”, optionally a “C₁₋₆ alkoxy group” and is an oxy group that is bonded to the previously defined C₁₋₂₀ alkyl, C₁₋₁₅ alkyl, C₁₋₁₂ alkyl, C₁₋₁₀ alkyl, C₁₋₈ alkyl, or C₁₋₆ alkyl group respectively. Specifically, examples of “C₁₋₂₀ alkoxy group” include methoxy group, ethoxy group, n-propoxy group, iso-propoxy group, n-butoxy group, iso-butoxy group, sec-butoxy group, tert-butoxy group, n-pentyloxy group, iso-pentyloxy group, sec-pentyloxy group, n-hexyloxy group, iso-hexyloxy group, n-hexyloxy group, n-heptyloxy group, n-octyloxy group, n-nonyloxy group, n-decyloxy group, n-undecyloxy group, n-dodecyloxy group, n-tridecyloxy group, n-tetradecyloxy group, n-pentadecyloxy group, n-hexadecyloxy group, n-heptadecyloxy group, n-octadecyloxy group, n-nonadecyloxy group, n-eicosyloxy group, 1,1-dimethylpropoxy group, 1,2-dimethylpropoxy group, 2,2-dimethylpropoxy group, 2-methylbutoxy group, 1-ethyl-2-methylpropoxy group, 1,1,2-trimethylpropoxy group, 1,1-dimethylbutoxy group, 1,2-dimethylbutoxy group, 2,2-dimethylbutoxy group, 2,3-dimethylbutoxy group, 1,3-dimethylbutoxy group, 2-ethylbutoxy group, 2-methylpentyloxy group, 3-methylpentyloxy group and the like.

An aryloxy group is optionally a “C₅₋₂₀ aryloxy group”, optionally a “C₆₋₁₂ aryloxy group”, optionally a “C₆₋₁₀ aryloxy group” and is an oxy group that is bonded to the previously defined C₅₋₂₀ aryl, C₆₋₁₂ aryl, or C₆₋₁₀ aryl group respectively.

An alkylthio group is optionally a “C₁₋₂₀ alkylthio group”, optionally a “C₁₋₁₅ alkylthio group”, optionally a “C₁₋₁₂ akylthio group”, optionally a “C₁₋₁₀ alkylthio group”, optionally a “C₁₋₈ alkylthio group”, optionally a “C₁₋₆ alkylthio group” and is a thio (—S—) group that is bonded to the previously defined C₁₋₂₀ alkyl, C₁₋₁₅ alkyl, C₁₋₁₂ alkyl, C₁₋₁₀ alkyl, C₁₋₈ alkyl, or C₁₋₆ alkyl group respectively.

An arylthio group is optionally a “C₅₋₂₀ arylthio group”, optionally a “C₆₋₁₂ arylthio group”, optionally a “C₆₋₁₀ arylthio group” and is a thio (—S—) group that is bonded to the previously defined C₅₋₂₀ aryl, C₆₋₁₂ aryl, or C₆₋₁₀ aryl group respectively.

An alkylaryl group is optionally a “C₆₋₁₂ aryl C₁₋₂₀ alkyl group”, optionally a “C₆₋₁₂ aryl C₁₋₁₆ alkyl group”, optionally a “C₆₋₁₂ aryl C₁₋₆ alkyl group” and is an aryl group as defined above bonded at any position to an alkyl group as defined above. The point of attachment of the alkylaryl group to a molecule may be via the alkyl portion and thus, optionally, the alkylaryl group is —CH₂-Ph or —CH₂CH₂-Ph. An alkylaryl group can also be referred to as “aralkyl”.

A silyl group is optionally —Si(R₅)₃, wherein each R₅ can be independently an aliphatic, heteroaliphatic, alicyclic, heteroalicyclic, aryl or heteroaryl group as defined above. Optionally, each R₅ is independently an unsubstituted aliphatic, alicyclic or aryl. Optionally, each R₅ is an alkyl group selected from methyl, ethyl or propyl.

A silyl ether group is optionally a group OSi(R₆)₃ wherein each R₆ can be independently an aliphatic, heteroaliphatic, alicyclic, heteroalicyclic, aryl or heteroaryl group as defined above. Each R₆ can be independently an unsubstituted aliphatic, alicyclic or aryl. Optionally, each R₆ is an optionally substituted phenyl or optionally substituted alkyl group selected from methyl, ethyl, propyl or butyl (such as n-butyl (nBu) or tert-butyl (tBu)). Exemplary silyl ether groups include OSi(Me)₃, OSi(Et)₃, OSi(Ph)₃, OSi(Me)₂(tBu), OSi(tBu)₃ and OSi(Ph)₂(tBu).

A nitrile group (also referred to as a cyano group) is a group CN.

An Imine group is a group —CRNR, optionally —CHNR₇ wherein R₇ is an aliphatic, heteroaliphatic, alicyclic, heteroalicyclic, aryl or heteroaryl group as defined above. R₇ may be unsubstituted aliphatic, alicyclic or aryl. Optionally R₇ is an alkyl group selected from methyl, ethyl or propyl.

An acetylide group contains a triple bond —C≡C—R₉, optionally wherein R₉ can be hydrogen, an aliphatic, heteroaliphatic, alicyclic, heteroalicyclic, aryl or heteroaryl group as defined above. For the purposes of the invention when R₉ is alkyl, the triple bond can be present at any position along the alkyl chain. R₉ may be unsubstituted aliphatic, alicyclic or aryl. Optionally R₉ is methyl, ethyl, propyl or phenyl.

An amino group is optionally —NH₂, —NHR₁₀ or —N(R₁₀)₂ wherein R₁₀ can be an aliphatic, heteroaliphatic, alicyclic, heteroalicyclic, a silyl group, aryl or heteroaryl group as defined above. It will be appreciated that when the amino group is N(R₁₀)₂, each R₁₀ group can be the same or different. Each R₁₀ may independently an unsubstituted aliphatic, alicyclic, silyl or aryl. Optionally R₁₀ is methyl, ethyl, propyl, SiMe₃ or phenyl.

An amido group is optionally —NR₁₁C(O)— or —C(O)—NR₁₁— wherein R₁₁ can be hydrogen, an aliphatic, heteroaliphatic, alicyclic, heteroalicyclic, aryl or heteroaryl group as defined above. R₁₁ may be unsubstituted aliphatic, alicyclic or aryl. Optionally R₁₁ is hydrogen, methyl, ethyl, propyl or phenyl. The amido group may be terminated by hydrogen, an aliphatic, heteroaliphatic, alicyclic, heteroalicyclic, aryl or heteroaryl group.

An ester group, unless otherwise defined herein, is optionally —OC(O)R₁₂— or —C(O)OR₁₂— wherein R₁₂ can be an aliphatic, heteroaliphatic, alicyclic, heteroalicyclic, aryl or heteroaryl group as defined above. R₁₂ may be unsubstituted aliphatic, alicyclic or aryl. Optionally R₁₂ is methyl, ethyl, propyl or phenyl. The ester group may be terminated by an aliphatic, heteroaliphatic, alicyclic, heteroalicyclic, aryl or heteroaryl group. It will be appreciated that if R₁₂ is hydrogen, then the group defined by —OC(O)R₁₂— or —C(O)OR₁₂— will be a carboxylic acid group.

A sulfoxide is optionally —S(O)R₁₃ and a sulfonyl group is optionally —S(O)₂R₁₃ wherein R₁₃ can be an aliphatic, heteroaliphatic, alicyclic, heteroalicyclic, aryl or heteroaryl group as defined above. R₁₃ may be unsubstituted aliphatic, alicyclic or aryl. Optionally R₁₃ is methyl, ethyl, propyl or phenyl.

A carboxylate group is optionally —OC(O)R₁₄, wherein R₁₄ can be hydrogen, an aliphatic, heteroaliphatic, alicyclic, heteroalicyclic, aryl or heteroaryl group as defined above. R₁₄ may be unsubstituted aliphatic, alicyclic or aryl. Optionally R₁₄ is hydrogen, methyl, ethyl, propyl, butyl (for example n-butyl, isobutyl or tert-butyl), phenyl, pentafluorophenyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, trifluoromethyl or adamantyl.

An acetamide is optionally MeC(O)N(R₁₅)₂ wherein R₁₅ can be hydrogen, an aliphatic, heteroaliphatic, alicyclic, heteroalicyclic, aryl or heteroaryl group as defined above. R₁₅ may be unsubstituted aliphatic, alicyclic or aryl. Optionally R₁₅ is hydrogen, methyl, ethyl, propyl or phenyl.

A phosphinate group is optionally-OP(O)(R₁₆)₂ or —P(O)(OR₁₆)(R₁₆) wherein each R₁₆ is independently selected from hydrogen, or an aliphatic, heteroaliphatic, alicyclic, heteroalicyclic, aryl or heteroaryl group as defined above. R₁₆ may be aliphatic, alicyclic or aryl, which are optionally substituted by aliphatic, alicyclic, aryl or C₁₋₆alkoxy. Optionally R₁₆ is optionally substituted aryl or C₁₋₂₀ alkyl, optionally phenyl optionally substituted by C₁₋₆alkoxy (optionally methoxy) or unsubstituted C₁₋₂₀alkyl (such as hexyl, octyl, decyl, dodecyl, tetradecyl, hexadecyl, stearyl). A phosphonate group is optionally —P(O)(OR₁₆)₂ wherein R₁₆ is as defined above. It will be appreciated that when either or both of R₁₆ is hydrogen for the group —P(O)(OR₁₆)₂, then the group defined by —P(O)(OR₁₆)₂ will be a phosphonic acid group.

A sulfinate group is optionally —S(O)OR₁₆ or —OS(O)R₁₇ wherein R₁₇ can be hydrogen, an aliphatic, heteroaliphatic, haloaliphatic, alicyclic, heteroalicyclic, aryl or heteroaryl group as defined above. R₁₇ may be unsubstituted aliphatic, alicyclic or aryl. Optionally R₁₇ is hydrogen, methyl, ethyl, propyl or phenyl. It will be appreciated that if R₁₇ is hydrogen, then the group defined by —S(O)OR₁₇ will be a sulfonic acid group.

A carbonate group is optionally —OC(O)OR₁₈, wherein R₁₈ can be hydrogen, an aliphatic, heteroaliphatic, alicyclic, heteroalicyclic, aryl or heteroaryl group as defined above. R₁₈ may be optionally substituted aliphatic, alicyclic or aryl. Optionally R₁₈ is hydrogen, methyl, ethyl, propyl, butyl (for example n-butyl, isobutyl or tert-butyl), phenyl, pentafluorophenyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, trifluoromethyl, cyclohexyl, benzyl or adamantyl. It will be appreciated that if R₁₇ is hydrogen, then the group defined by —OC(O)OR₁₈ will be a carbonic acid group.

A carbonate functional group is —OC(O)O— and may be derived from a suitable source. Generally, it is derived from CO₂.

In an -alkylC(O)OR₁₉ or -alkylC(O)R₁₉ group, R₁₉ can be hydrogen, an aliphatic, heteroaliphatic, alicyclic, heteroalicyclic, aryl or heteroaryl group as defined above. R₁₉ may be unsubstituted aliphatic, alicyclic or aryl. Optionally R₁₉ is hydrogen, methyl, ethyl, propyl, butyl (for example n-butyl, isobutyl or tert-butyl), phenyl, pentafluorophenyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, trifluoromethyl or adamantyl.

An ether group is optionally —OR₂₀ wherein R₂₀ can be an aliphatic, heteroaliphatic, alicyclic, heteroalicyclic, aryl or heteroaryl group as defined above. R₂₀ may be unsubstituted aliphatic, alicyclic or aryl. Optionally R₂₀ is methyl, ethyl, propyl, butyl (for example n-butyl, isobutyl or tert-butyl), phenyl, pentafluorophenyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, trifluoromethyl or adamantyl.

It will be appreciated that where any of the above groups are present in a Lewis base G, one or more additional R groups may be present, as appropriate, to complete the valency. For example, in the context of an amino group, an additional R group may be present to give RNHR₁₀, wherein R is hydrogen, an optionally substituted aliphatic, heteroaliphatic, alicyclic, heteroalicyclic, aryl or heteroaryl group as defined above. Optionally, R is hydrogen or aliphatic, alicyclic or aryl.

When the suffix “ene” is used in conjunction with a chemical group, e.g. “alkylene”, this is intended to mean the group as defined herein having two points of attachment to other groups. As used herein, the term “alkylene”, by itself or as part of another substituent, refers to alkyl groups that are divalent, i.e., with two points of attachment to two other groups.

As used herein, the term “optionally substituted” means that one or more of the hydrogen atoms in the optionally substituted moiety is replaced by a suitable substituent. Unless otherwise indicated, an “optionally substituted” group may have a suitable substituent at each substitutable position of the group, and when more than one position in any given structure may be substituted with more than one substituent selected from a specified group, the substituent may be either the same or different at every position. Combinations of substituents envisioned by this invention are optionally those that result in the formation of stable compounds. The term “stable”, as used herein, refers to compounds that are chemically feasible and can exist for long enough at room temperature i.e. (16-25° C.) to allow for their detection, isolation and/or use in chemical synthesis.

Optional substituents for use in the present invention include, but are not limited to, halogen, hydroxy, nitro, carboxylate, carbonate, alkoxy, aryloxy, alkylthio, arylthio, heteroaryloxy, alkylaryl, amino, amido, imine, nitrile, silyl, silyl ether, ester, sulfoxide, sulfonyl, acetylide, phosphinate, sulfonate or optionally substituted aliphatic, heteroaliphatic, alicyclic, heteroalicyclic, aryl or heteroaryl groups (for example, optionally substituted by halogen, hydroxy, nitro, carbonate, alkoxy, aryloxy, alkylthio, arylthio, amino, imine, nitrile, silyl, sulfoxide, sulfonyl, phosphinate, sulfonate or acetylide).

It will be appreciated that although in formula (VII), the groups X and G are illustrated as being associated with a single M₁ or M₂ metal centre, one or more X and G groups may form a bridge between the M₁ and M₂ metal centres.

For the purposes of the present invention, the epoxide substrate is not limited. The term epoxide therefore relates to any compound comprising an epoxide moiety (i.e. a substituted or unsubstituted oxirane compound). Substituted oxiranes include monosubstituted oxiranes, disubstituted oxiranes, trisubstituted oxiranes, and tetrasubstituted oxiranes. Epoxides may comprise a single oxirane moiety. Epoxides may comprise two or more oxirane moieties.

It will be understood that the term “an epoxide” is intended to encompass one or more epoxides. In other words, the term “an epoxide” refers to a single epoxide, or a mixture of two or more different epoxides. For example, the epoxide substrate may be a mixture of ethylene oxide and propylene oxide, a mixture of cyclohexene oxide and propylene oxide, a mixture of ethylene oxide and cyclohexene oxide, or a mixture of ethylene oxide, propylene oxide and cyclohexene oxide.

The term cyclic anhydride relates to any compound comprising an anhydride moiety in a ring system. In preferred embodiments, the anhydrides which are useful in the present invention have the following formula:

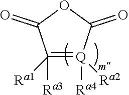

Wherein m″ is 1, 2, 3, 4, 5, or 6 (preferably 1 or 2), each R^{a1}, R^{a2}, R^{a3} and R^{a4} is independently selected from hydrogen, halogen, hydroxyl, nitro, alkoxy, aryloxy, heteroaryloxy, amino, alkylamino, imine, nitrile, acetylide, carboxylate or optionally substituted aliphatic, heteroaliphatic, alicyclic, heteroalicyclic, aryl, heteroaryl, alkylaryl or alkylheteroaryl, or a polymeric species (e.g. polybis(phenol)A); or two or more of R^{a1}, R^{a2}, R^{a3} and R^{a4} can be taken together to form a saturated, partially saturated or unsaturated 3 to 12 membered, optionally substituted ring system, optionally containing one or more heteroatoms, or can be taken together to form a double bond. Each Q is independently C, O, N or S, preferably C, wherein R^{a3} and R^{a4} are either present, or absent, and can either be [symbol] or

[symbol]

according to the valency of Q. It will be appreciated that when
Q is C, and [symbol] is [symbol]
R^{a3} and R^{a4} (or two R^{a4} on adjacent carbon atoms) are absent.

Preferable anhydrides are set out below.

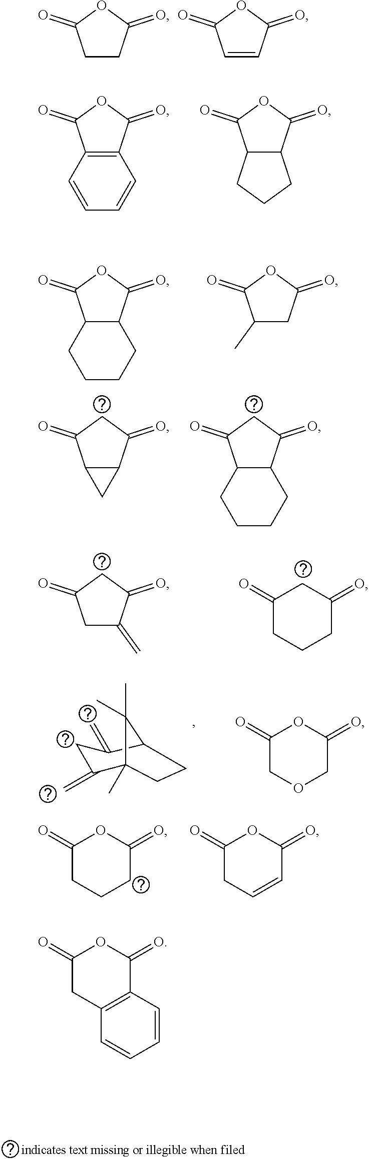

The term cyclic ester includes a lactone which relates to any cyclic compound comprising a-C(O)O— moiety in the ring. In preferred embodiments, the cyclic esters which are useful in the present invention have the following formula:

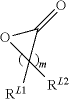

wherein m is 1 to 20 (e.g. 1, 2, 3, 4, 5, 6, 7, 8, 9, 10, 11, 12, 13, 14, 15, 16, 17, 18, 19 or 20), preferably 2, 4, or 5; and R^{L1} and R^{L2} are independently selected from hydrogen, halogen, hydroxyl, nitro, alkoxy, aryloxy, heteroaryloxy, amino, alkylamino, imine, nitrile, acetylide, carboxylate or optionally substituted aliphatic, heteroaliphatic, alicyclic, heteroalicyclic, aryl, heteroaryl, alkylaryl or alkylheteroaryl. Two or more of R^{L1} and R^{L2} can be taken together to form a saturated, partially saturated or unsaturated 3 to 12 membered, optionally substituted ring system, optionally containing one or more heteroatoms. When m is 2 or more, the R^{L1} and R^{L2} on each carbon atom may be the same or different. Preferably R^{L1} and R^{L2} are selected from hydrogen or alkyl. Preferably, the lactone has the following structure:

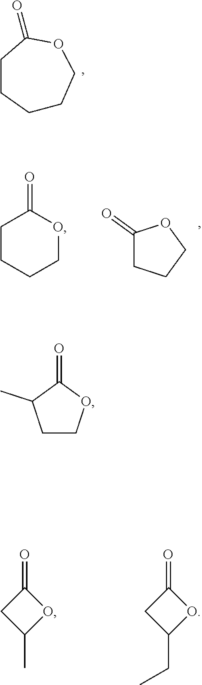

The term cyclic ester also includes cyclic diesters containing two ester groups. In preferred embodiments, the cyclic diesters which are useful in the present invention have the following formula:

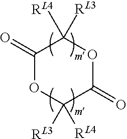

Wherein m′ is 1, 2, 3, 4, 5, 6, 7, 8, 9 or 10, (preferably 1 or 2, more preferably, 1) and R^{L3} and R^{L4} are independently selected from hydrogen, halogen, hydroxyl, nitro, alkoxy, aryloxy, heteroaryloxy, amino, alkylamino, imine, nitrile, acetylide, carboxylate or optionally substituted aliphatic, heteroaliphatic, alicyclic, heteroalicyclic, aryl, heteroaryl, alkylaryl or alkylheteroaryl. Two or more of R^{L3} and R^{L4} can be taken together to form a saturated, partially saturated or unsaturated 3 to 12 membered, optionally substituted ring system, optionally containing one or more heteroatoms, When m′ is 2 or more, the R^{L3} and R^{L4} on each carbon atom may be the same or different or one or more R^{L3} and R^{L4} on adjacent carbon atoms can be absent, thereby forming a double or triple bond. It will be appreciated that while the compound has two moieties represented by (—CR^{L3}R^{L4})ₘ′, both moieties will be identical. In particularly preferred embodiments, m′ is 1, R^{L4} is H, and R^{L} Is H, hydroxyl or a C₁₋₆alkyl, preferably methyl. The stereochemistry of the moiety represented by (—CR^{L3}R^{L4})ₘ′ can either be the same (for example RR-lactide or SS-lactide), or different (for example, meso-lactide). The cyclic diester may be a racemic mixture, or may be an optically pure isomer. Preferably, the cyclic diester has the following formula:

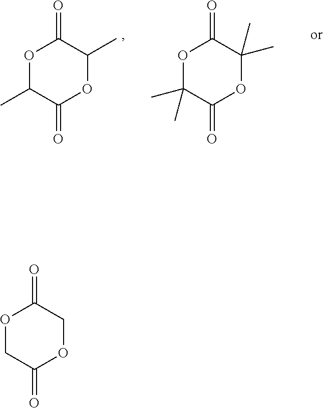

The term “cyclic ester” used herein encompasses a lactone, a cyclic di-ester such as a lactide and a combination thereof. Preferably, the term “cyclic ester” means a lactone or a cyclic diester.

Preferred optional substituents of the groups R^{e1}, R^{e2}, R^{e3}, R^{e4}, R^{a1}, R^{a2}, R^{a3}, R^{a4}, R^{L1}, R^{L2}, R^{L3} and R^{L4} include halogen, nitro, hydroxyl, unsubstituted aliphatic, unsubstituted heteroaliphatic unsubstituted aryl, unsubstituted heteroaryl, alkoxy, aryloxy, heteroaryloxy, amino, alkylamino, imine, nitrile, acetylide, and carboxylate.

The term (poly)ol block copolymer generally refers polyol block copolymers or mono-ol block copolymers. Accordingly, the block copolymers have at least one, preferably at least two or more terminal ends with —OH groups.

By way of example, at least about 90%, at least about 95%, at least about 98% or at least about 99% of polymers may be terminated at each end with —OH groups. The skilled person will appreciate that if the polymer is linear, then it may be capped at both ends with —OH groups. If the polymer is branched, each of the branches may be capped with —OH groups. Such polymers are generally useful in preparing higher polymers such as polyurethanes. The chains may comprise a mixture of functional groups (e.g. —OH and —SH) groups, or may contain the same functional group (e.g. all-OH groups).

By the term reaction/copolymerisation or reaction/polymerisation is meant that in the case of a single repeat unit a reaction is indicated whereas in the case of multiple repeat units a copolymerisation or polymerisation is indicated.

By the term (poly)ester, (poly)ether and (poly)ether carbonate is meant that there may be only one reaction residue and no repeat units—an ester, ether, ethercarbonate or there may be a number of repeat units—polyester, polyether and polyethercarbonate.

Accordingly, for the avoidance of doubt a “block” may be a single reaction residue with no repeat units.

The term “continuous” used herein can be defined as the mode of addition of materials or may refer to the nature of the reaction method as a whole.

In terms of continuous mode of addition, the relevant materials are continually or constantly added during the course of a reaction. This may be achieved by, for example, adding a stream of material with either a constant flow rate or with a variable flow rate. In other words, the one or more materials are added in an essentially non-stop fashion. It is noted, however, that non-stop addition of the materials may need to be briefly interrupted for practical considerations, for example to refill or replace a container of the materials from which these materials are being added.

In terms of a whole reaction being continuous, the reaction may be conducted over a long period of time, such as a number of days, weeks, months, etc. In such a continuous reaction, reaction materials may be continually topped-up and/or products of the reaction may be tapped-off. It will be appreciated that although catalysts may not be consumed during a reaction, catalysts may in any case require topping-up, since tapping-off may deplete the amount of catalyst present.

A continuous reaction may employ continuous addition of materials.

A continuous reaction may employ a discontinuous (i.e. batch-wise or semi batch-wise) addition of materials

The term series used herein refers to when two or more reactors are connected so that the crude reaction mixture can flow from the first reactor to the second reactor.

The term nested used herein refers to when two or more reactors are configured so that one is located within the other. For example in the present invention, when the second reactor is located inside the first reactor, allowing the conditions of both reactors to influence the other.

### EXAMPLES

### Methods and Analysis

The polymer products were characterised by ¹H NMR spectroscopy, using the same method as taught in U.S. Pat. No. 9,296,859 with the following additions:
I5: Instead of double bond from incorporated Malic anhydride (CH2, 6.22-6.29 ppm) I5 is instead either:
Incorporated Phthalic anhydride (2×CH, 7.5 ppm) or incorporated Succinic Anhydride (2×CH₂, 2.55 ppm).
I6: Unreacted anhydride: Phthalic Anhydride at 7.9 ppm (2*CH); Succinic Anhydride at 2.95 ppm (2*CH2).

In each case, ¹H NMR can be used to calculate the quantity of cyclic carbonate relative to the starter material from either or both reaction 1—polycarbonate reaction and reaction 3 polyether reaction (if a different starter is used to activate the DMC in reaction 3). This is done by comparing the cyclic carbonate-CH integral at 4.5 ppm to the integral of the starter (Hexanediol OCH₂CH₂ at 1.75 ppm, TMPEO-CH₃ at 0.85 ppm). The change in proportion of cyclic carbonate to starter molecules can then be used to calculate how much carbonate polyol from reaction 1 is decomposing to cyclic carbonate in reaction 3.

### Catalyst 1:

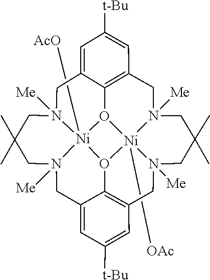

The following describes a typical example of the invention:

### Reaction 1:

A 100 mL reactor was charged with starter 1 (e.g. Hexanediol, 1.05 g) and dried under vacuum at approx. 100° C. before addition of 1 bar CO2 pressure. Catalyst 1 was dissolved in PO (20 ml) and added to the reactor. The mixture was stirred and heated 10 to 70° C., and CO₂ added at 10 barg.

### Reaction 2:

After the mixture had stirred for a number of hours (e.g 6 hours), the reaction was cooled and vented. To the mixture was added solid anhydride (phthalic Anhydride, 5.16 g, 2 eq. per starter-OH) which undergoes preferential copolymerisation with unreacted epoxide from reaction 1, catalysed by catalyst 1. The reactor was resealed, re-pressurised with CO₂ and stirred for a further 6 hours at ca. 70° C./10 barg before being cooled to <15° C. and a sample taken for analysis by ¹H NMR and GPC. In examples 5 and 7 the reactor was only re-pressurised with 0.5 bar CO₂ during reaction 2. In example 6, the anhydride was added to the reaction 1 product and the mixture was not resealed and repressurised. Instead, it was directly transferred into reaction 3 without a further stirring period. In example 7 an additional 50% of catalyst 1 was added in with the anhydride. The % of unreacted anhydride was calculated.

The B-A-Z—Z—Z-A-B carbonate/ester polyol product was then poured into a Schlenk and mixed with EtOAc (10 ml) and PO (3 mL).

### Reaction 3:

In a separate reactor, starter 2 (PPG400, 0.2 ml) and DMC (9 mg) were dried under vacuum at 120° C./1 hour. After cooling, EtOAc (15 ml) was added under an atmosphere of N₂ and the mixture heated to approx. 130° C. The DMC was activated with 3 portions of PO (0.3 g) before being cooled to the target temperature (85° C.) by removal of the heating jacket.

The B-A-Z—Z—Z-A-B carbonate/ester polyol product mixture from reactions 1 & 2 was then added to the active DMC system by HPLC over approx. 1 hour and “cooked out” for a further hour once addition was completed. After cooling to <15° C., the reaction was analysed by ¹H NMR and GPC.

Examples 2-7 follow the same experimental using the reagents and conditions shown in table 1.

### Comparative Examples

Comparative examples follow the same protocol for examples of the invention except reaction 2 is not carried out. After reaction 1 the product carbonate polyol is removed from the reactor, diluted with EtOAc and PO and added into reaction 3 as described for the examples of the invention.

TABLE 1

| Examples | C1 | 1 | 2 | C2 | 3 | C4 | 4 | C5 | 5 | C6 | 6 | 7 |
|---|---|---|---|---|---|---|---|---|---|---|---|---|
| Starter | Hexane- | Hexane- | Hexane- | Hexane- | Hexane- | TMPEO | TMPEO | Pentaery- | Pentaery- | Hexane- | Hexane- | Hexane- |
| | diol | diol | diol | diol | diol | 450 | 450 | thritol | thritol | diol | diol | diol |
| | | | | | | | | prop- | pro- | | | |
| | | | | | | | | oxylate | poxylate | | | |
| Starter | 1.03 | 1.03 | 1.03 | 1.03 | 1.03 | 3.4 | 3.4 | 3.97 | 3.97 | 0.78 | 0.78 | 0.78 |
| Mass (g) | | | | | | | | | | | | |
| Anhydride | N/A | PA | SA | N/A | PA | N/A | PA | N/A | PA | N/A | PA | PA |
| Equiv. | N/A | 2 | 2 | N/A | 2 | N/A | 2 | N/A | 3 | N/A | 1.3 | 1 |
| anhydride/ | | | | | | | | | | | | |
| chain-OH | | | | | | | | | | | | |
| Addition | N/A | 6 | 6 | N/A | 6 | N/A | 6 | N/A | 16 | N/A | 12 | 12 |
| point (Hrs) | | | | | | | | | | | | |
| Reaction 3 | 100 | 100 | 100 | 85 | 85 | 85 | 85 | 85 | 120 | 120 | 120 | 120 |
| temperature | | | | | | | | | | | | |
| (C) | | | | | | | | | | | | |
| Cyclic | 0.72 | 0.25 | 0.15 | 0.55 | 0.23 | 33.78 | 0.33 | 12.33 | 0.34 | 1.51 | 0.43 | 0.51 |
| carbonate/ | | | | | | | | | | | | |
| polyol | | | | | | | | | | | | |
| carbonate | | | | | | | | | | | | |
| Anhydride | N/A | 9.1% | 9.0% | N/A | 9.6% | N/A | 22.1% | N/A | 21.6% | N/A | 11.6% | 15.5% |
| % in polyol | | | | | | | | | | | | |
| Mn (g/mol) | 2100 | 2300 | 2600 | 2200 | 2500 | 1400 | 1800 | 1200 | 1450 | 1700 | 2550 | 1900 |
| PDI | 1.20 | 1.17 | 1.30 | 1.22 | 1.19 | 1.27 | 1.29 | 1.27 | 1.30 | 1.23 | 1.51 | 1.19 |
| Increase | 2.80 | 0.46 | 0.21 | 2.68 | 0.78 | 8.8 | 0.30 | 4.9 | 0.65 | 5.3 | 1.8 | 1.4 |
| in mols | | | | | | | | | | | | |
| of cyclic per | | | | | | | | | | | | |
| starter from | | | | | | | | | | | | |
| Reaction 2 to | | | | | | | | | | | | |
| Reaction 3 | | | | | | | | | | | | |
| Polycarbonate | 25.3% | 3.8% | 4.8% | 21.6% | 6.4% | 95.0% | 3.1% | 57.0% | 7.1% | 50.2% | 15.3% | 10.7% |
| decomposition | | | | | | | | | | | | |
| during | | | | | | | | | | | | |
| Reaction 3/% | | | | | | | | | | | | |

The examples demonstrate that clearly in the absence of anhydride, significant degradation of the polycarbonate produced in reaction 1 is observed upon addition to reaction 3. This is measured either by the increase in the ratio of cyclic carbonate to the reaction 1 starter molecule or the calculated % of polycarbonate decomposition during reaction 3. The comparative examples clearly show significantly greater ratio of cyclic carbonate to starter and all show more than 20% decomposition of the polycarbonate polyol in reaction 3, In contrast to the examples of the invention where less than 10% degradation was observed even at 100° C. and little increase is observed in the ratio of cyclic carbonate to starter molecule. Examples C4, C5 and 4 and 5 respectively demonstrate this invention is particularly effective for polyols with functionality >2 (t>2), where comparative example C4 and C5 shows polycarbonate polyol degradation is almost complete upon addition to reaction 3, whereas the addition of anhydride prevents any significant degradation in example 4. The increase in the number of hydroxyl end groups for multifunctional polycarbonate polyols makes them more susceptible to unzipping from the chain end. Comparative example C6 shows that even with diols, higher reaction 3 temperatures lead to increased degradation, whereas examples 6 and 7 were carried out at a high reaction 3 temperature with substantially less decomposition. Example 6 demonstrates that even by adding in anhydride at the end of reaction 1 and transferring straight into reaction 3 a substantial benefit is seen. Example 7 shows that additional catalyst can be used for reaction 2.

1-108. (canceled)

109. A (poly)ol block copolymer comprising a polycarbonate or polyethercarbonate block, A (-A′-Z′—Z—(Z′-A′)ₙ-), (poly)ester blocks, B, and (poly)ethercarbonate or (poly)ether blocks, C, wherein the (poly)ol block copolymer has the polyblock structure:
C—B-A′-Z′—Z—(Z′-A′-B—C)ₙ
wherein n=t−1 and wherein t=the number of terminal OH group residues on the block A; and
wherein each A′ is independently a polycarbonate chain having at least 70% carbonate linkages, or a polyethercarbonate chain having at least 30% ether linkages, wherein each B is a (poly)ester block formed by epoxide and cyclic anhydride reaction/copolymerisation and/or cyclic ester ring-opening reaction/polymerisation, and each C is independently a (poly)ethercarbonate or (poly)ether block having 50-100% ether linkages; and
wherein Z′—Z—(Z′)ₙ is a starter residue.

110. The (poly)ol block copolymer according to claim 109, wherein -A′- has the following structure: 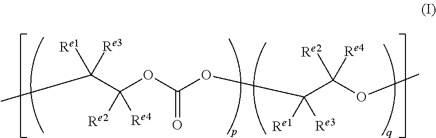
wherein in the case of the polycarbonate chain if q is not 0, the ratio of p:q is at least 7:3 and
wherein in the case of the polyethercarbonate chain the ratio of p:q is at least 3:7;
block B has one of the following structures 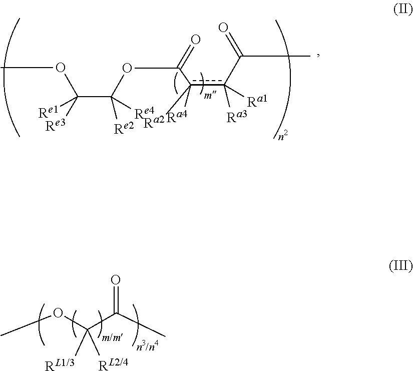
wherein n² is 1 or more and n³/n⁴ is 1 or more
and block C has the following structure: 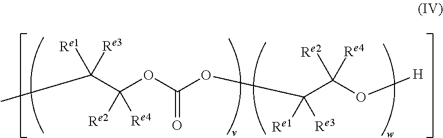
wherein w is 1 or more and v is 0 or more and if v is not 0, the ratio of w:v is at least 1:1;
with the proviso that if the total of n² and n³/n⁴ is 1 then w is at least 2 and if w is 1 then the total of n² and n³/n⁴ is at least 2;
R^{e1}, R^{e2}, R^{e3} and R^{e4} independently depend on the epoxide residue in the respective block;
R^{a1}, R^{a2}, R^{a3} and R^{a4} or R^{L1/L3}, R^{L2/L4}, m, m′ and m″ depend on the cyclic anhydride or ester residue in block B.

111. The (poly)ol block copolymer according to claim 110, wherein v=0 and block C is a (poly)ether.

112. The (poly)ol block copolymer according to claim 110, wherein v is 1 or more and block C is a (poly)ether carbonate.

113. The (poly)ol block copolymer according to claim 109, wherein the starter residue depends on the nature of the starter compound, and wherein the starter compound has the formula (V):
Z [symbol] R^{Z})ₐ (V)
wherein Z can be any group which can have 1 or more —RZ groups attached to it and may be selected from optionally substituted alkylene, alkenylene, alkynylene, heteroalkylene, heteroalkenylene, heteroalkynylene, cycloalkylene, cycloalkenylene, hererocycloalkylene, heterocycloalkenylene, arylene, heteroarylene, or Z may be a combination of any of these groups;
a is an integer which is at least 1;
wherein each R^{Z} may be —OH, —NHR′, —SH, —C(O)OH, —P(O)(OR′)(OH), —PR′(O)OH)₂ or —PR′(O)OH, optionally R⁷ is selected from —OH, —NHR′ or —C(O)OH, optionally each Rz is —OH, —C(O)OH or a combination thereof (e.g. each Rz is —OH);
wherein R′ may be H, or optionally substituted alkyl, heteroalkyl, aryl, heteroaryl, cycloalkyl or heterocycloalkyl, optionally R′ is H or optionally substituted alkyl; and
wherein Z′ corresponds to R^{z}, except that a bond replaces the labile hydrogen atom.

114. The (poly)ol block copolymer according to claim 113, wherein a is an integer which is at least 2.

115. The (poly)ol block copolymer according to claim 109, wherein the starter compound is selected from monofunctional starter substances such as alcohols, phenols, amines, thiols and carboxylic acid, for example, alcohols such as methanol, ethanol, 1- and 2-propanol, 1- and 2-butanol, linear or branched C₃-C₂₀-monoalcohol such as tert-butanol, 3-buten-1-ol, 3-butyn-1-ol, 2-methyl-3-buten-2-ol, 2-methyl-3-butyn-2-ol, propargyl alcohol, 2-methyl-2-propanol, 1-tert-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, 1-decanol, 1-dodecanol, phenol, 2-hydroxybiphenyl, 3-hydroxybiphenyl, 4-hydroxybiphenyl, 2-hydroxypyridine, 3-hydroxypyridine, and 4-hydroxypyridine, mono-ethers or esters of ethylene, propylene, polyethylene, polypropylene glycols such as ethylene glycol mono-methyl ether and propylene glycol mono-methyl ether, phenols such as linear or branched C₃-C₂₀ alkyl substituted phenols, for example nonyl-phenols or octyl phenols, monofunctional carboxylic acids such as formic acid, acetic acid, propionic acid and butyric acid, fatty acids, such as stearic acid, palmitic acid, oleic acid, linoleic acid, linolenic acid, benzoic acid and acrylic acid, and monofunctional thiols such as ethanethiol, propane-1-thiol, propane-2-thiol, butane-1-thiol, 3-methylbutane-1-thiol, 2-butene-1-thiol, and thiophenol, or amines such as butylamine, tert-butylamine, pentylamine, hexylamine, aniline, aziridine, pyrrolidine, piperidine, and morpholine; and/or selected from diols such as 1,2-ethanediol (ethylene glycol), 1-2-propanediol, 1,3-propanediol (propylene glycol), 1,2-butanediol, 1-3-butanediol, 1,4-butanediol, 1,5-pentanediol, 1,6-hexanediol, 1,8-octanediol, 1,10-decanediol, 1,12-dodecanediol, 1,4-cyclohexanediol, 1,2-diphenol, 1,3-diphenol, 1,4-diphenol, neopentyl glycol, catechol, cyclohexenediol, 1,4-cyclohexanedimethanol, dipropylene glycol, diethylene glycol, tripropylene glycol, triethylene glycol, tetraethylene glycol, polypropylene glycols (PPGs) or polyethylene glycols (PEGs) having an Mn of up to about 1500 g/mol, such as PPG 425, PPG 725, PPG 1000 and the like, triols such as glycerol, benzenetriol, 1,2,4-butanetriol, 1,2,6-hexanetriol, tris(methylalcohol)propane, tris(methylalcohol)ethane, tris(methylalcohol)nitropropane, trimethylol propane, polyethylene oxide triols, polypropylene oxide triols and polyester triols, tetraols such as calix[4]arene, 2,2-bis(methylalcohol)-1,3-propanediol, erythritol, pentaerythritol or polyalkylene glycols (PEGs or PPGs) having 4-OH groups, polyols, such as sorbitol or polyalkylene glycols (PEGs or PPGs) having 5 or more —OH groups, or compounds having mixed functional groups including ethanolamine, diethanolamine, methyldiethanolamine, and phenyldiethanolamine.

116. The (poly)ol block copolymer according to claim 109, wherein the (poly)ol molecular weight (Mn) is in the range 300-20,000 Da and the molecular weight (Mn) of block A is in the range 200-4000 Da, wherein the molecular weight (Mn) of block B is in the range 50-5000 Da, and wherein the molecular weight (Mn) of block C is in the range 100-20,000 Da.

117. The (poly)ol block copolymer according to claim 109, wherein block A is a polycarbonate and typically, has between 75% and 99% carbonate linkages.

118. The (poly)ol block copolymer according to claim 109, wherein block C has between 0% and 50% carbonate linkages.

119. The (poly)ol block copolymer according to claim 109, wherein block C has between 50% and 100% ether linkages.

120. The (poly)ol block copolymer according to claim 109, wherein block A further comprises ether linkages.

121. The (poly)ol block copolymer according of claim 120, wherein block A has between 1% and 25% ether linkages.

122. The (poly)ol block copolymer according to claim 120, wherein the epoxide is asymmetric and the polycarbonate has between 40-100% head to tail linkages.

123. The (poly)ol block copolymer according to claim 109, wherein block A is a generally alternating polycarbonate (poly)ol residue.

124. The (poly)ol block copolymer according to claim 109, wherein the mol/mol ratio of epoxide residues in block A to epoxide and, optionally, cyclic ester residues in block B and C combined is in the range 25:1 to 1:250.

125. The (poly)ol block copolymer according to claim 109, where t is 2 or more.

126. The (poly)ol block copolymer according to claim 109, wherein block C is a polyether chain selected from the group consisting of polyoxymethylene, poly(ethylene oxide), polypropylene oxide), poly(butylene oxide), poly(glycidylether oxide), poly(chloromethylethylene oxide), poly(cyclopentene oxide), poly(cyclohexene oxide) and poly(3-vinyl cyclohexene oxide).

127. The (poly)ol block copolymer according to claim 109, wherein at least 30% of the epoxide residues of block A are ethylene oxide or propylene oxide residues.

128. The (poly)ol block copolymer according to claim 109, wherein at least 30% of the epoxide residues of block C, and block B if present therein, are ethylene oxide or propylene oxide residues.

129. The (poly)ol block copolymer according to claim 109, wherein t=1 and the polyblock structure is: C—B-A′-Z′—Z

130. A composition comprising the (poly)ol block copolymer of claim 109 and one or more additives selected from catalysts, blowing agents, stabilizers, plasticisers, fillers, flame retardants, and antioxidants.

131. The composition according to claim 130 further comprising a (poly)isocyanate.

132. A polyurethane produced from the reaction of a polyol block copolymer according to claim 109.

133. The polyurethane according to claim 132, wherein the polyurethane is in the form of a soft foam, a flexible foam, an integral skin foam, a high resilience foam, a viscoelastic or memory foam, a semi-rigid foam, a rigid foam (such as a polyurethane (PUR) foam, a polyisocyanurate (PIR) foam and/or a spray foam), an elastomer (such as a cast elastomer, a thermoplastic elastomer (TPU) or a microcellular elastomer), an adhesive (such as a hot melt adhesive, pressure sensitive or a reactive adhesive), a sealant or a coating (such as a waterborne or solvent dispersion (PUD), a two-component coating, a one component coating, a solvent free coating).

134. An isocyanate terminated polyurethane prepolymer comprising a composition according to claim 130 with an excess of (poly)isocyanate.

135. A lubricant composition comprising a (poly)ol block copolymer according to claim 109.

136. A surfactant composition comprising a (poly)ol block copolymer according to claim 109.

137. The product according to claim 109, wherein the epoxides are selected from cyclohexene oxide, styrene oxide, ethylene oxide, propylene oxide, butylene oxide, substituted cyclohexene oxides (such as limonene oxide, C₁₀H₁₆O or 2-(3,4-epoxycyclohexyl)ethyltrimethoxysilane, C₁₁H₂₂O), alkylene oxides (such as ethylene oxide and substituted ethylene oxides), unsubstituted or substituted oxiranes (such as oxirane, epichlorohydrin, 2-(2-methoxyethoxy)methyl oxirane (MEMO), 2-(2-(2-methoxyethoxy)ethoxy)methyl oxirane (ME2MO), 2-(2-(2-(2-methoxyethoxy)ethoxy)ethoxy)methyl oxirane (ME3MO), 12-epoxybutane, glycidyl ethers, glycidyl esters, glycidyl carbonates, vinyl-cyclohexene oxide, 3-phenyl-1,2-epoxypropane, 2,3-epoxybutane, isobutylene oxide, cyclopentene oxide, 2,3-epoxy-1,2,3,4-tetrahydronaphthalene, indene oxide, and functionalized 3,5-dioxaepoxides.

138. The product according to claim 109, wherein the cyclic anhydride or cyclic esters are selected from the groups: 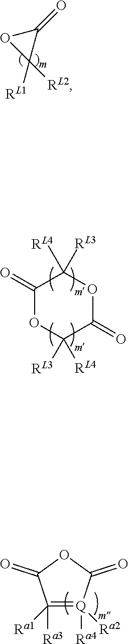
wherein: m is 1 to 20, m′ is 1 to 10 and m″ is 1 to 6;
R^{L1} and R^{L2} are independently selected from hydrogen, halogen, hydroxyl, nitro, alkoxy, aryloxy, heteroaryloxy, amino, alkylamino, imine, nitrile, acetylide, carboxylate or optionally substituted aliphatic, heteroaliphatic, alicyclic, heteroalicyclic, aryl, heteroaryl, alkylaryl or alkylheteroaryl, wherein two or more of R^{L1} and R^{L2} can optionally be taken together to form a saturated, partially saturated or unsaturated 3 to 12 membered, optionally substituted ring system, optionally containing one or more heteroatoms;
R^{L3} and R^{L4} are independently selected from hydrogen, halogen, hydroxyl, nitro, alkoxy, aryloxy, heteroaryloxy, amino, alkylamino, imine, nitrile, acetylide, carboxylate or optionally substituted aliphatic, heteroaliphatic, alicyclic, heteroalicyclic, aryl, heteroaryl, alkylaryl or alkylheteroaryl wherein, two or more of R^{L3} and R^{L4} can optionally be taken together to form a saturated, partially saturated or unsaturated 3 to 12 membered, optionally substituted ring system, optionally containing one or more heteroatoms; and wherein one or more R^{L3} and R^{L4} on adjacent carbon atoms can optionally be absent, thereby forming a double or triple bond;
R^{a1}, R^{a2}, R^{a3} and R^{a4} are independently selected from hydrogen, halogen, hydroxyl, nitro, alkoxy, aryloxy, heteroaryloxy, amino, alkylamino, imine, nitrile, acetylide, carboxylate or optionally substituted aliphatic, heteroaliphatic, alicyclic, heteroalicyclic, aryl, heteroaryl, alkylaryl or alkylheteroaryl, or a polymeric species (e.g. polybis(phenol)A); wherein two or more of R^{a1}, R^{a2}, R^{a3} and R^{a4} can optionally be taken together to form a saturated, partially saturated or unsaturated 3 to 12 membered, optionally substituted ring system, optionally containing one or more heteroatoms, or can be taken together to form a double bond;
each Q is independently C, O, N or S, typically C, wherein R^{a3} and R^{a4} are either present, or absent, and [symbol] can either be [symbol] or [symbol] , according to the valency of Q.

139. The product according to claim 109, wherein the cyclic anhydride is selected from the group consisting of:

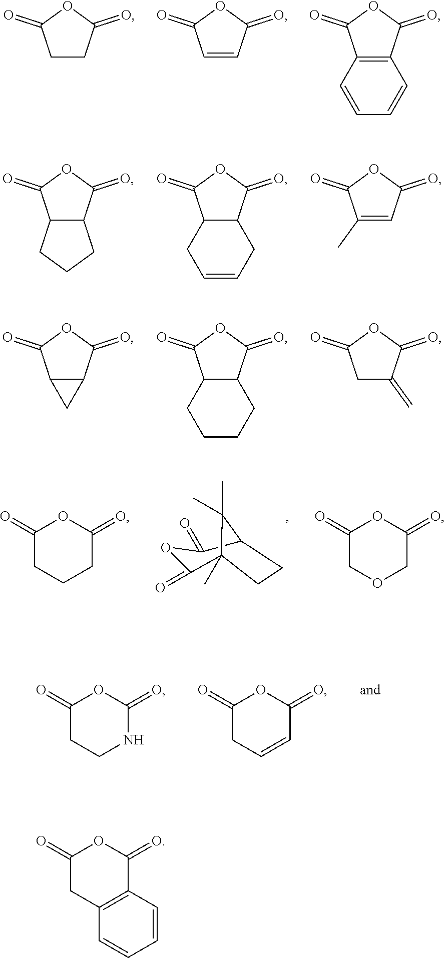

140. The product according to claim 109, wherein the cyclic ester is selected from the group consisting of: [chemical structure]
